(19) United States
(12) Patent Application Publication
(10) Pub. No.: US 2021/0056458 A1
(43) Pub. Date: Feb. 25, 2021

(54) PREDICTING A PERSONA CLASS BASED ON OVERLAP-AGNOSTIC MACHINE LEARNING MODELS FOR DISTRIBUTING PERSONA-BASED DIGITAL CONTENT

(71) Applicant: Adobe Inc., San Jose, CA (US)

(72) Inventors: Margarita Savova, Jersey City, NJ (US); Matvey Kapilevich, Irvington, NY (US); Lakshmi Shivalingaiah, San Francisco, CA (US); Anup Rao, San Jose, CA (US); Alexandru Ionut Hodorogea, Bucharest (RO); Harleen Singh Sahni, Washington, DC (US)

(21) Appl. No.: 16/545,224

(22) Filed: Aug. 20, 2019

(51) Int. Cl. G06N 20/00; G06N 5/02

(52) U.S. Cl. CPC G06N 20/00; G06N 5/02

(57) ABSTRACT

The present disclosure relates to systems, non-transitory computer-readable media, and methods for intelligently predicting a persona class of a client device and/or target user utilizing an overlap-agnostic machine learning model and distributing persona-based digital content to the client device. In particular, in one or more embodiments, the persona classification system can learn overlap-agnostic machine learning model parameters to apply to user traits in real-time or in offline batches. For example, the persona classification system can train and utilize an overlap-agnostic machine learning model that includes an overlap-agnostic embedding model, a trained user-embedding generation model, and a trained persona prediction model. By applying the learned overlap-agnostic machine learning model parameters to the target user traits, the persona classification system can predict a persona class for sending digital content based on the predicted persona class.

### BACKGROUND

Recent years have seen significant improvements in computer systems for analyzing attributes of client devices and corresponding users for distributing digital content to such client devices across computer networks. For example, conventional digital content distribution systems can employ various analytics techniques to identify client devices and distribute targeted digital content. To illustrate, some conventional systems can analyze a digital input trait that corresponds to a new client device, determine the input trait to be similar relative to one or more other traits of a historical segment population, and can therefore determine the client device as also belonging to the historical segment population. However, a number of problems exist with these and other conventional systems, particularly in relation to inaccuracy of identifying client devices and corresponding users, inefficiency in analyzing traits with sufficient speed to work in real-time implementations and avoid exhausting (or wasting) computing resources, and limited scope of operation in relation to client devices and/or users with sparse (non-overlapping) data traits.

### BRIEF SUMMARY

Aspects of the present disclosure address the foregoing and/or other problems in the art with methods, computer-readable media, and systems that intelligently train overlap-agnostic machine learning models to predict persona classes of client devices and/or target users in a target audience and for sending persona-based digital content to the client devices. For example, in some embodiments, the disclosed systems can employ a smart segment algorithm to analyze a target audience, and based on the analysis, determine a propensity that a given client device/target user belongs to at least one of a plurality of personas within the target audience. Further, in connection with the client device/target user corresponding to a particular distinct persona, the disclosed systems can select and distribute customized digital content unique to the particular distinct persona. By using the smart segment algorithm, the disclosed systems can take an arbitrary target audience and determine with precision and speed an appropriate persona class for client devices/target users, even where the client devices/target users do not have traits that overlap with traits historically associated with the persona class.

To illustrate, in some embodiments, the disclosed systems identify a target user of a client device and determine user traits corresponding to the target user. In addition, the disclosed systems can determine a persona class for the target user. For example, the disclosed systems can utilize an overlap-agnostic embedding model to generate a plurality of trait embeddings from the traits corresponding to the target user. The disclosed systems can then utilize a user-embedding generation model to generate a user embedding for the target user. Based on the user embedding, the disclosed systems can apply a persona prediction model to generate a predicted persona class for the target user and provide targeted digital content to the client device of the user based on the predicted persona class. In this manner, the disclosed systems can accurately and efficiently determine persona classes corresponding to client devices and corresponding users, offline or in real-time, without requiring overlapping traits between incoming client devices/users and historical users corresponding to the persona class.

Additional features and advantages of one or more embodiments of the present disclosure are outlined in the following description.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a persona classification system can operate in accordance with one or more embodiments.

FIG. 2 illustrates an example process flow for determining a predicted persona class in accordance with one or more embodiments.

FIG. 3 illustrates an example process flow for training an overlap-agnostic embedding model in accordance with one or more embodiments.

FIG. 4 illustrates an example process flow for training a user-embedding generation model in accordance with one or more embodiments.

FIG. 5 illustrates an example process flow for training a persona prediction model in accordance with one or more embodiments.

FIG. 6A illustrates a sequence diagram for determining a predicted persona class in accordance with one or more embodiments.

FIG. 6B illustrates a diagram for determining a predicted persona class within a target audience in accordance with one or more embodiments.

FIG. 7A illustrates a schematic diagram for determining a predicted persona class in accordance with one or more embodiments.

FIG. 7B illustrates a diagram for determining predicted persona classes for client devices in real time in accordance with one or more embodiments.

FIGS. 8A-8F illustrate example user interfaces for creating and deploying an overlap-agnostic machine learning model in accordance with one or more embodiments.

FIG. 9 illustrates an example schematic diagram of a persona classification system in accordance with one or more embodiments.

FIG. 10 illustrates a flowchart of a series of acts for determining a persona class in accordance with one or more embodiments.

FIG. 11 illustrates a block diagram of an example computing device for implementing one or more embodiments of the present disclosure.

### DETAILED DESCRIPTION

This disclosure describes one or more embodiments of a persona classification system that intelligently trains and applies one or more overlap-agnostic machine learning models to determine persona classes for target client devices and/or corresponding target users. In particular, the persona classification system can use a smart segments algorithm to learn and compare embeddings, which enables the persona classification system to infer relationships and leverage connections between traits (e.g., between traits of the target user and traits of training users associated with a given persona class). For example, the persona classification system can receive from an administrator device a chosen target audience and persona classes, and the persona classification system can then predict a persona class for target users of the target audience. By training an overlap-agnostic machine learning model based on trait embeddings, the persona classification system can accurately and flexibly determine persona classes for target users without the need for overlap between target user traits and traits of historical users corresponding to the persona class. Furthermore, by applying learned overlap-agnostic machine learning parameters, the persona classification system can efficiently predict persona classes for target user in real-time (e.g., within milliseconds as client devices access digital assets) and/or offline (e.g., in a batch with other target users).

As mentioned above, the persona classification system can train an overlap-agnostic machine learning model based on trait embeddings. In particular, in one or more embodiments, the persona classification system generates trait embeddings using an overlap-agnostic embedding model and then utilizes these trait embeddings to train the remainder of the overlap-agnostic machine learning model. For example, the persona classification system can utilize an overlap-agnostic embedding model that utilizes min-hash signatures in conjunction with singular value decomposition (“SVD”) to generate embeddings for various traits.

By utilizing an overlap-agnostic embedding model, the persona classification system can generate trait embeddings that reflect similarities between traits in vector space without requiring explicit overlap between users sharing the traits themselves. For example, the overlap-agnostic embedding model can generate trait embeddings that reflect similarities between 26-year-old target users and 27-year-old target users in a vector space, even though no overlap exists between the two populations. Accordingly, in some embodiments, the persona classification system can compare embeddings of traits corresponding to users to identify personas corresponding to the users, even when no express overlap exists between the persona class (or historical users corresponding to the persona class) and the user traits.

Upon generating trait embeddings, the persona classification system can utilize the trait embeddings to train other components of the overlap-agnostic machine learning model. For example, the persona classification system can utilize trait embeddings to train a user-embedding generation model. To illustrate, the persona classification system can train a user-embedding generation model to analyze a plurality of user traits and generate a weighted user-embedding from trait embeddings corresponding to the plurality of user traits. Specifically, in one or more embodiments, the persona classification system trains the user embedding model as a linear regression model that learns trait-persona weights that align user-traits to known personas. Thus, once trained, the user-embedding generation model can apply the trait-persona weights to trait embeddings of traits corresponding to a target user and generate a user embedding corresponding to the target user.

In addition to training the user-embedding generation model, the persona classification system can also train a persona prediction model as part of the overlap-agnostic machine learning model. For example, the persona classification system can train a persona prediction model to analyze user embeddings and determine persona classes corresponding to target users. To illustrate, in some embodiments, the persona classification system utilizes a persona prediction model as a logistic regression model that learns parameters to map user embeddings to corresponding personas. Thus, once trained, the persona prediction model can apply learned parameters to a user embedding of a target user and accurately predict a persona corresponding to the target user.

As mentioned, the persona classification system can apply learned parameters of the overlap-agnostic machine learning model to determine persona classes for target users. For example, when operating offline, the persona classification system can analyze traits for a batch of target users and identify persona classes corresponding to the target users. Specifically, the persona classification system can utilize the overlap-agnostic embedding model to determine trait embeddings corresponding to the traits, utilize the user-embedding generation model to generate a user embedding from the trait embeddings, and utilize the persona prediction model to predict personas from the user embeddings.

As noted above, the trait embeddings and/or user embeddings generated as part of the overlap-agnostic machine learning model can indicate similarity between embeddings within a vector space. Accordingly, in some embodiments, the persona classification system can generate user embeddings and persona embeddings and directly compare the user embeddings with the persona embeddings. For example, the persona classification system can determine distances between the user embeddings and the persona embeddings in vector space and identify personas that are nearest to the user embeddings.

As mentioned, the persona classification system can also operate online in real-time to identify target users of client devices as the client devices access digital assets. In some embodiments, the persona classification system generates coefficients from parameters of the overlap-agnostic machine learning model and applies the coefficients in real-time to distribute digital content. For example, in some embodiments, the persona classification system identifies client devices accessing digital assets (e.g., websites or applications), determines traits corresponding to the client devices, and applies the parameters of the overlap-agnostic machine learning model (e.g., coefficients for traits reflecting the learned parameters) to determine personas of the target users corresponding to the client devices. The persona classification system can then provide digital content to the client devices based on the determined personas while the client devices access a digital asset (e.g., while the client devices access a website).

As mentioned above, a number of problems exist with conventional systems, particularly in relation to accuracy, efficiency, and scope of operation. As one example, conventional persona classification systems often fail to accurately predict persona classes for client devices and corresponding target users, particularly in scenarios where time and information is scarce. For example, when a client device accesses a digital asset (e.g., for a first time or after a long period of time), conventional persona classification systems often have limited information regarding the client device and corresponding target user and thus provide digital content poorly aligned to the client device. In particular, due to non-sticky third-party cookies, conventional persona classification systems often have little digital information regarding a client device and struggled to accurately identify or classify a target user. To help remedy this predicament, conventional systems in some cases rely on purchased third-party data with more granular segmentation, and then overlay a target audience with the third-party segments. However, in many instances there is little or no overlap between the traits of the target audience and the traits of third-party segments. Consequently, conventional persona classification systems (e.g., “Look-Alike” models) often fail to have requisite information to accurately classify client devices and/or corresponding target users because the traits of the target audience do not necessarily look like the traits of the third-party segments. Other remedial approaches like A/B testing are also inaccurate, for example, due to anecdotal target audience creation at the outset.

As another example problem, conventional persona classification systems are limited in scope or reach. For example, administrative devices often run campaigns to target client devices and/or target users that have exhibited a particular targeted characteristic (e.g., client devices that have interacted with a website within a threshold period of time). Within this population of target users, administrative devices also seek to tailor digital content to target users based on an additional unknown characteristics (e.g., based on different occupations, such as Interior Designer, Fine Artist, and Photographer). To help remedy this predicament, conventional systems may attempt to collect data by asking users to specify their occupation. However, this approach excludes client devices and users that browse anonymously, (which is often the vast majority). Accordingly, conventional persona classification systems are often unable to flexibly target these additional client devices on a granular level.

In yet another example, conventional systems operate inefficiently. For example, conventional systems can require significant time and computing resources to classify target users. Accordingly, conventional systems are ill-suited to circumstances demanding quick responses (such as targeting digital content in response to trending news or events), while maintaining accuracy and minimal latency. In particular, conventional persona classification systems can take days to collect data to build a baseline for a look-alike audience; run an offline look-alike model to discover look-alikes; and/or activate a look-alike audience. Given the time needed to implement these models (or perform other testing approaches, such as A/B testing), many conventional systems are unsuitable for real-time application. Additionally or alternatively, some conventional persona classification systems may need to setup a separate model for different segments in a target audience. Thus, in addition to increased processing times, conventional persona classification systems can also require increased amounts of computational overhead.

The persona classification system of the present disclosure provides many advantages and benefits over these conventional systems and methods. For example, by training and utilizing an overlap-agnostic machine learning model, the persona classification system can analyze traits of a target user to accurately predict a persona class for the target user in real-time or offline. More specifically, by learning overlap-agnostic machine learning model parameters based on trait embeddings, user embeddings, and persona embeddings, the persona classification system can account for the many relationships and degrees of relationships between traits, independent of trait-overlap, to predict an accurate persona class for the target user. In this manner, the persona classification can accurately activate a target user with persona-based digital content in real-time (e.g., while a target user accesses a digital asset), even when information regarding a particular target user is sparse.

In addition to improving accuracy of persona class predictions, the persona classification system of the present disclosure improves scope or reach in comparison to conventional systems. For example, and as mentioned above, by learning the overlap-agnostic machine learning model parameters based on trait embeddings, the persona classification system can extrapolate beyond available user traits to predict a persona class of increased granularity. In this manner, the persona classification system and/or a content distribution system can predict persona classes for target users, even without overlapping traits between historical users of a persona class and the target user.

Moreover, the persona classification system can increase operational efficiency compared to conventional systems. For example, the persona classification system can reduce computational overhead relative to conventional systems by using an overlap-agnostic machine learning model. For example, as described above, the overlap-agnostic machine learning model can utilize a linear regression model and/or logistic regression model that requires very little computational power or time. Thus, the persona classification system can avoid the excessive computer resources needed to train and/or apply conventional models for each persona in a target audience. The persona classification system can also operate in real-time and/or in batch mode as applicable for most appropriately responding to time-sensitive applications. Indeed, the persona classification system can monitor client device interactions (e.g., responses to trending news or events), update parameters of the overlap-agnostic machine learning model, and apply the parameters of the overlap-agnostic machine learning model in moments (rather than days required by conventional systems). For example, in some embodiments, the persona classification system can utilize both real-time and batch approaches to predict a persona class of a target user. In an example scenario, the persona classification system can efficiently predict a persona class of a target user in real-time notwithstanding incomplete information about a device associated with the target user. Then, utilizing the batch approach, the persona classification system can update/further specify the prediction of the persona class for the target user with additional information regarding the client device associated with the target user.

As illustrated by the foregoing discussion, the present disclosure utilizes a variety of terms to describe features and advantages of the persona classification system. Additional detail is now provided regarding these and other terms used herein. For example, as used herein, the term “trait” refers to a characteristic or feature. In particular, a trait can include a characteristic or feature of a client device and/or user corresponding to a client device. To illustrate, a trait can include qualities such as age, gender, location, type of computing device, type of operating system, subscription status with respect to an online service or computer application, interaction event (e.g. an event from an interaction history), purchase event (e.g., an event from a purchase history), preference, or interest.

In addition, as used herein, the term “persona class” refers to a classification or category. In particular a persona class can include a class or category defined by one or more traits or characteristics associated with a user or client device. For example, a persona class can refer to a particular population of users associated with the same trait(s) or characteristic(s).

As used herein, a “machine learning model” refers to a computer representation that can be tuned (e.g., trained) based on inputs to approximate unknown functions. For instance, a machine-learning model can include, but is not limited to, a differentiable function approximator, a neural network (e.g., a convolutional neural network or deep learning model), a decision tree (e.g., a gradient boosted decision tree), a linear regression model, a logistic regression model, association rule learning, inductive logic programming, support vector learning, Bayesian network, regression-based model, principal component analysis, or a combination thereof.

Relatedly, as used herein, the term “overlap-agnostic machine learning model” refers to a machine learning model that determines or predicts persona classes independent based on traits (i.e., without requiring) trait overlap. In particular, the overlap-agnostic machine learning model refers to a machine learning model that can analyze traits of a client device and/or target user and predict a persona class corresponding to the client device and/or target user (without requiring overlap between the traits of the client device and/or target user and traits of the persona class). Thus, the overlap-agnostic machine learning includes a machine learning model that can determine that a target user is associated with a persona class, even when the target user is not associated with traits that match the persona class or traits of historical users that belong to the persona class.

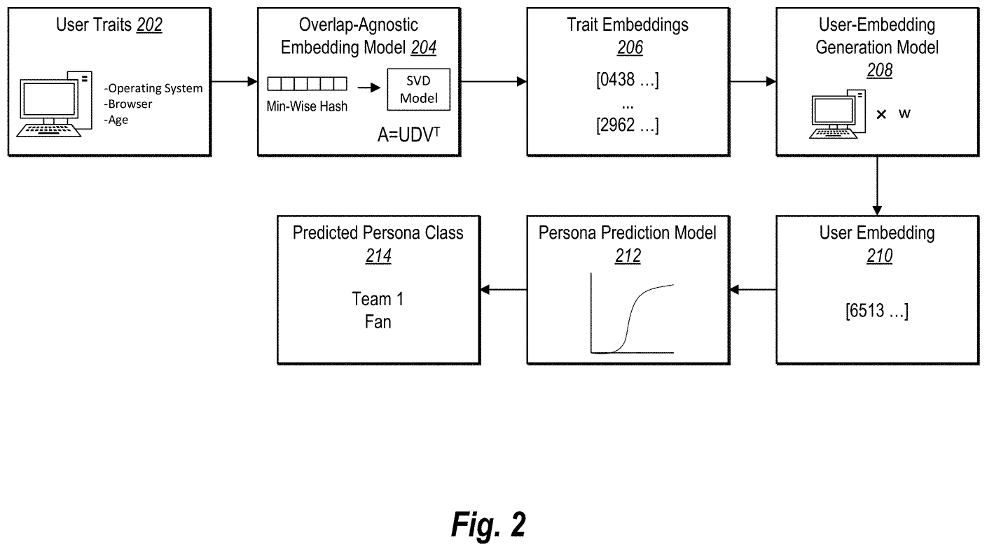

As discussed above, the overlap-agnostic machine learning model can include multiple sub-models. For instance, the overlap-agnostic machine learning model can include an overlap-agnostic embedding model that generates trait embeddings from input traits. Further, the overlap-agnostic machine learning model can include a user-embedding generation model that generates user-embeddings from trait embeddings via learned trait-persona weights (i.e., weights that align traits of users/client devices to known personas during training). Still further, the overlap-agnostic machine learning model can include a persona prediction model that predicts persona classes based on user embeddings. Additional detail regarding overlap-agnostic embedding models, user-embedding generation models, and persona prediction models is provided below (e.g., in relation to FIGS. 2-5, 6A-6B, and 7A-7B).

Relatedly, the term “train” refers to utilizing information to tune or teach a machine learning model. The term “training” (used as an adjective or descriptor, such as “training user” or “training trait”) refers to information or data utilized to tune or teach a machine learning model. In some embodiments, the persona classification system trains an overlap-agnostic machine learning model based on various training users and training traits (corresponding to known persona classes). Further, as used herein, the term “embedding” refers to a numerical representation of one or more traits. In particular, an embedding can include a vector representation of one or more traits generated by an overlap-agnostic embedding model. Examples of an embedding include a trait embedding (an embedding of a single trait), a user embedding (an embedding of one or more traits corresponding to a user), and a persona embedding (an embedding of one or more traits corresponding to a persona class). As mentioned, the persona classification system can generate embeddings that reflect similarity within a vector space without requiring overlap. Thus, in some embodiments, the distance in vector space between embeddings will reflect the similarity of two traits, even when those traits do not have any overlapping populations (e.g., a 26-year-old age trait and a 27-year-old age trait).

Further, as used herein, the term “singular value decomposition model” refers to a computer algorithm or model that performs factorization on a real or complex matrix. In particular, a singular value decomposition model refers to a computer algorithm that analyzes a matrix to determine the left-singular vectors, the singular values, and the right-singular vectors of the matrix. For example, the singular value decomposition model can refer to a machine learning model.

As used herein, the term “sketch” refers to an approximation of input data that reduces the dimensionality of the input data while preserving one or more key statistics. For instance, as applied to traits of a group of users (e.g., a target audience), a sketch refers to an approximation of a persona class within a population. In particular, a sketch refers to a collection of data or values that summarizes or approximates a trait (e.g., at a reduced dimensionality) while preserving one or more statistical characteristics of the trait. For example, a sketch can include a collection of data that is a compressed version of a larger collection of data that represents a persona class. Relatedly, as used herein, a “sketch vector” refers to a data structure (e.g., a vector) that includes (e.g., stores) a collection of data or values corresponding to a sketch. Specifically, a sketch vector can have one or more value slots containing data that summarizes or approximates a persona class within a population.

Additionally, as used herein, the term “digital content” refers to content or data that is transmittable over a communication network (e.g., the Internet or an intranet). In particular, digital content includes webpage content, targeted digital campaign content, application content, social networking content, search engine content, or other content transmittable over a network. For example, digital content can include text, images, audio, and/or audiovisual content. For instance, digital content can include images on a webpage, a list of search results, displayed features of an application, or in image targeted specifically to a user as part of a digital content campaign.

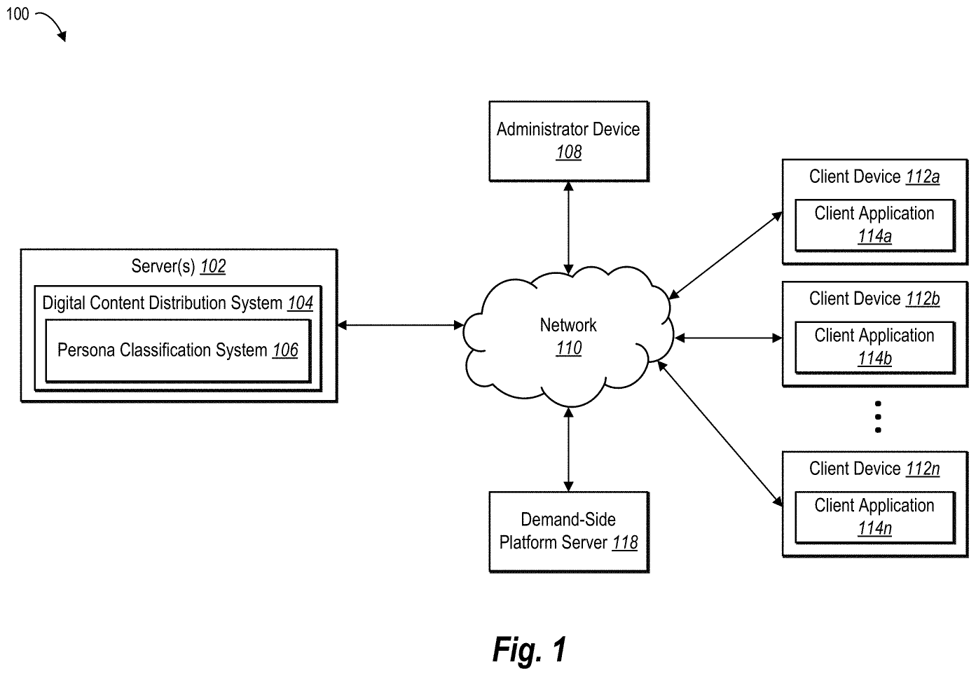

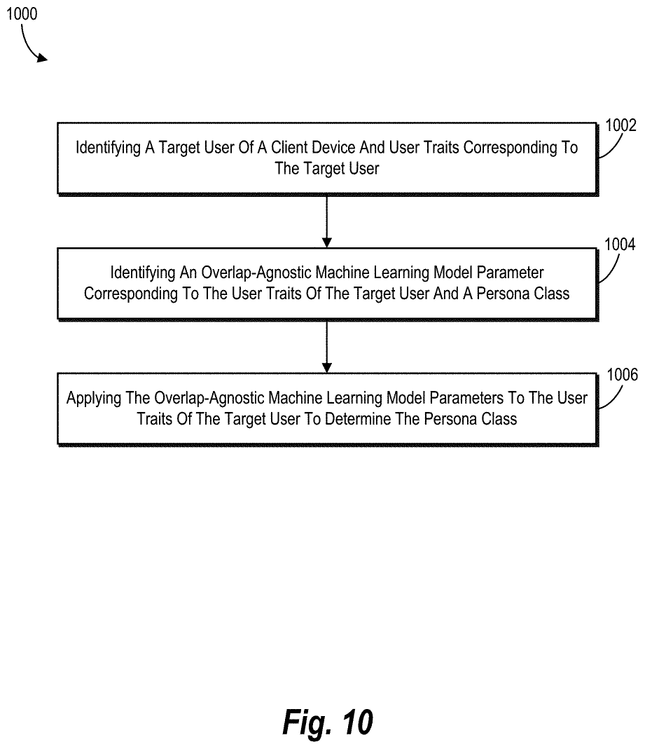

As mentioned above, the persona classification system can provide digital content to client devices while client devices access one or more digital assets. As used herein, the term “digital asset” refers to refers a digital platform through which digital content can be presented. For example, a digital asset can include a website, an application on a client device, or a video provided by a publisher through a network. Additional detail will now be provided regarding the persona classification system in relation to illustrative figures portraying example embodiments and implementations of the persona classification system. For example, FIG. 1 illustrates a computing system environment (or “environment”) 100 for implementing a persona classification system 106 in accordance with one or more embodiments. As shown in FIG. 1, the environment 100 includes server(s) 102, an administrator device 108, a network 110, client devices 112a-112n, and a demand-side platform (DSP) server 118. Each of the components of the environment 100 can communicate via the network 110, and the network 110 may be any suitable network over which computing devices can communicate. Example networks are discussed in more detail below in relation to FIG. 10.

As shown in FIG. 1, the environment 100 includes the client devices 112a-112n. The client devices 112a-112n can each be one of a variety of computing devices, including a smartphone, tablet, smart television, desktop computer, laptop computer, virtual reality device, augmented reality device, or other computing device as described in relation to FIG. 10. Although FIG. 1 illustrates multiple client devices 112a-112n, in some embodiments the environment 100 can include a single client device 112. The client devices 112a-112n can further communicate with the server(s) 102 via the network 110. For example, the client devices 112a-112n can receive user input and provide information pertaining to the user input (e.g., that relates to a digital asset provided by a remote server) to the server(s) 102.

As shown, each of the client devices 112a-112n includes a corresponding client application 114a-114n. In particular, the client applications 114a-114n may be a web application, a native application installed on the client devices 112a-112n (e.g., a mobile application, a desktop application, etc.), or a cloud-based application where part of the functionality is performed by the server(s) 102. The client applications 114a-114n can present or display information to respective users, including a digital asset. Additionally or alternatively, the client applications 114a-114n can present or display digital content specific to the users (e.g., based on a corresponding persona class for each of the users). The users can interact with the client applications 114a-114n to provide user input to, for example, access a digital asset.

As mentioned, the environment 100 includes the administrator device 108. The administrator device 108 can include a variety of computing device as described in relation to FIG. 10. The administrator device 108 can generate and/or provide information regarding a digital content campaign, such as digital content to provide to client devices. In addition, the administrator device 108 can generate or provide campaign parameters, such as a target audience, campaign duration, or budget. In some embodiments, the administrator device 108 can define persona classes within a target audience (and different digital content to provide to the different persona classes). Although FIG. 1 illustrates a single administrator device 108, in some embodiments the environment 100 can include multiple different administrator devices 108. The administrator device 108 can further communicate with the server(s) 102 via the network 110. For example, the administrator device 108 can receive user input and provide information pertaining to the user input (e.g., campaign parameters, a batch of target user data, etc.) to the server(s) 102. As shown in FIG. 1, the environment 100 includes the DSP server 118. The DSP server 118 can assist in providing digital content to client-devices (e.g., in real-time). For example, the DSP server 118 can identify client devices and impression opportunities (e.g., advertising space on a website or application) and purchase impression opportunities for entities distributing digital content. In some embodiments, the DSP server 118 operates within a real-time bidding environment by conducting an auction for impression opportunities as client devices access digital assets. The DSP server 118 can identify bids (based on campaign parameters), identify a winning bidder, and provide digital content to client devices (e.g., based on the winning bidder).

As illustrated in FIG. 1, the environment 100 includes the server(s) 102. The server(s) 102 may learn, generate, store, receive, and transmit electronic data, such as executable instructions for determining a persona class of a target user and/or sending persona-based digital content to the target user. For example, the server(s) 102 may receive data from the client device 112a based on user input to access a digital asset (e.g., a website). In turn, the server(s) 102 can transmit data (e.g., persona classification data) to one or more components in the environment 100. For example, the server(s) 102 can send to the administrator device 108 a predicted persona class for a target user (in this case, a user associated with the client device 112a). Additionally or alternatively, the server(s) 102 can send to the DSP server 118 one or more overlap-agnostic machine learning model parameters for determining the persona class of the target user.

Further, according to this example, based on the persona classification data generated by the persona classification system 106, one or more components in the environment 100 may send persona-based digital content to the client device 112a (e.g., the digital content distribution system 104, the administrator device 108, and/or the DSP server 118). The server(s) 102 can communicate with any of the client devices 112a-112n to transmit and/or receive data via the network 110. In some embodiments, the server(s) 102 comprises a content server and/or a data collection server. The server(s) 102 can also comprise an application server, a communication server, a web-hosting server, a social networking server, or a digital content management server.

Although FIG. 1 depicts a persona classification system 106 located on the server(s) 102, in some embodiments, the persona classification system 106 may be implemented by on one or more other components of the environment 100 (e.g., by being located entirely or in part at one or more of the other components). For example, the persona classification system 106 may be implemented by the administrator device 108, the DSP server 118, and/or a third-party device.

As shown in FIG. 1, the persona classification system 106 is implemented as part of a digital content distribution system 104 located on the server(s) 102. The digital content distribution system 104 can organize, manage, and/or execute digital content distribution campaigns. For example, the digital content distribution system 104 can identify campaign parameters and distribute digital content to client devices based on the campaign parameters. The digital content distribution system 104 can also send persona classification data to one or more components of the environment 100 for generating persona-based digital content to send to the client devices 112a-112n via the network 110.

In some embodiments, though not illustrated in FIG. 1, the environment 100 may have a different arrangement of components and/or may have a different number or set of components altogether. For example, the environment 100 may include a third-party server (e.g., for storing persona classification data or other data). As another example, the client devices 112a-112n may communicate directly with the persona classification system 106, bypassing the network 110.

As mentioned above, the persona classification system 106 can predict a persona class for a target user. FIG. 2 illustrates an example process flow by which the persona classification system 106 determines a predicted persona class 214 in accordance with one or more embodiments of the present disclosure.

As illustrated, the persona classification system 106 identifies user traits 202 that correspond to a client device of a target user (e.g., the client devices 112a-112n associated with users of FIG. 1). For example, the persona classification system 106 can identify a client device accessing a digital asset. The persona classification system 106 can determine one or more traits corresponding to the client device and/or the user of the client device as the user traits 202. To illustrate, as shown in FIG. 2, the persona classification system 106 can determine an operating system utilized at the client device, a browser utilized by the client device, and/or an age of the target user.

The persona classification system 106 can detect or identify the user traits 202 in a variety of ways. For example, the persona classification system 106 send a query to a client device or directly detect features utilized by a client device to access a digital asset. In some embodiments, the persona classification system 106 can utilize a digital repository of information that aligns traits of a user to a client device identifier (e.g., aligns features to an IP address). In some circumstances, the persona classification system 106 receives a batch of target users with corresponding traits from a remote server for analysis. In these or other embodiments, the persona classification system 106 can provide restrictions on trait data (e.g., restrictions due to lack of purchased rights, a privacy policy, etc.) utilized in providing digital content. For example, the persona classification system 106 can place restrictions on trait data based on target user traits, persona classes, training user traits associated with learned parameters, etc.

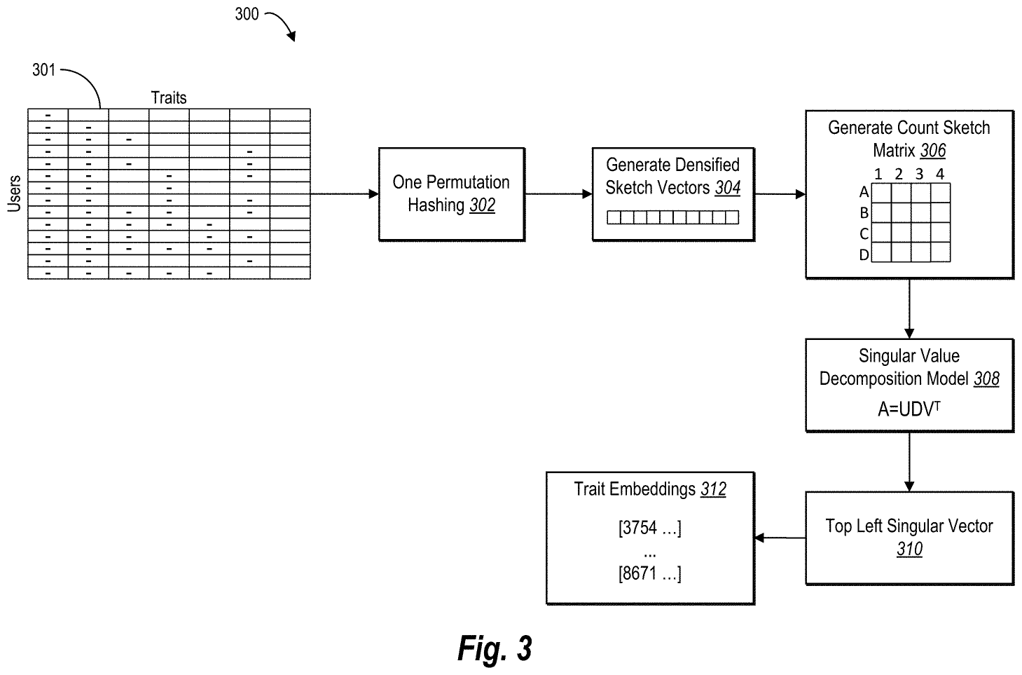

As shown in FIG. 2, the persona classification system 106 analyzes the user traits 202 utilizing an overlap-agnostic embedding model 204, which generates trait embeddings 206. In particular, as illustrated, the persona classification system 106 can utilize min-wise hashing and singular value decomposition to generate embeddings to generate trait embeddings. By utilizing min-wise hashing and singular value decomposition, the persona classification system 106 can generate trait embeddings that reflect similarities between traits within a virtual space. Thus, even though particular trait populations may not overlap, the persona classification system 106 can generate trait embeddings that reflect similarities between the traits. In some embodiments, the persona classification system 106 can analyze traits from a large repository of training users and generate a database of trait embeddings that correspond to individual traits. The persona classification system 106 can then utilize the database to identify trait embeddings for any particular trait corresponding to a target user. Additional detail regarding generating such overlap-agnostic trait embeddings is provided below (e.g., in relation to FIG. 3).

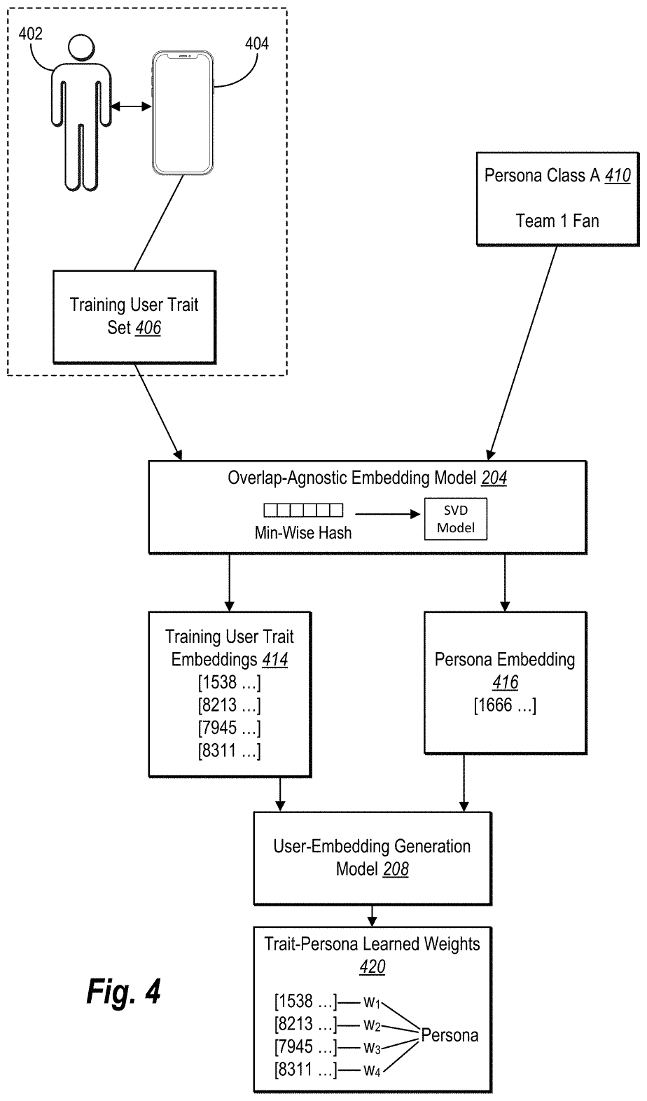

As further illustrated in FIG. 2, the persona classification system 106 then analyzes the trait embeddings 206 utilizing a user-embedding generation model 208 for generating a user embedding 210. In particular, the user-embedding generation model 208 can include a linear regression model that applies trait-persona weights to individual traits to generate a user-embedding. Specifically, the persona classification system 106 can train the user-embedding generation model 208 by learning trait-persona weights that map training traits of training users to known persona classes corresponding to the training users. The persona classification system 106 can then implement the user-embedding generation model by applying the trait-persona weights to trait embeddings of a target user to generate a user embedding. Additional detail regarding training the user-embedding generation model is provided below (e.g., in relation to FIG. 4)

Moreover, as shown in FIG. 2, the persona classification system 106 then analyzes the user embedding 210 utilizing a persona prediction model 212 for determining the predicted persona class 214. In particular, the persona prediction model 212 can include a logistic regression model that applies learned parameters to user embeddings to determine persona classes corresponding to target users. The persona classification system 106 can train the persona prediction model 212 by learning parameters that map individual user embeddings to known persona classes. The persona classification system 106 can then implement the persona prediction model to determine the predicted persona class 214. Although the predicted persona class 214 is shown as “Team 1 Fan,” the persona classification system 106 can provide additional or alternative indications (e.g., identify multiple persona classes). Indeed, the persona classification system 106 can provide predictions for multiple personas (e.g., if distances between persona classes and a user embeddings satisfies a threshold). For example, in some embodiments the persona classification system 106 provides an indication for each target user illustrating persona classes that satisfy a threshold.

As shown in FIG. 2, based on the predicted persona class 214, the digital content distribution system 104 may send persona-based digital content to the target user. For instance, the persona classification system 106 can determine that a user belongs to a target audience for a digital content campaign. Based on the predicted persona class 214, the persona classification system 106 can then distribute unique digital content specific to the persona class 214 to the target user.

As illustrated in FIG. 2, the overlap-agnostic machine learning model of the persona classification system 106 includes the overlap-agnostic embedding model 204, the user-embedding generation model 208, and the persona prediction model 212. In some embodiments, the persona classification system 106 can employ each of the overlap-agnostic embedding model 204, the user-embedding generation model 208, and the persona prediction model 212 to determine the predicted persona class 214 as illustrated in the process flow of FIG. 2.

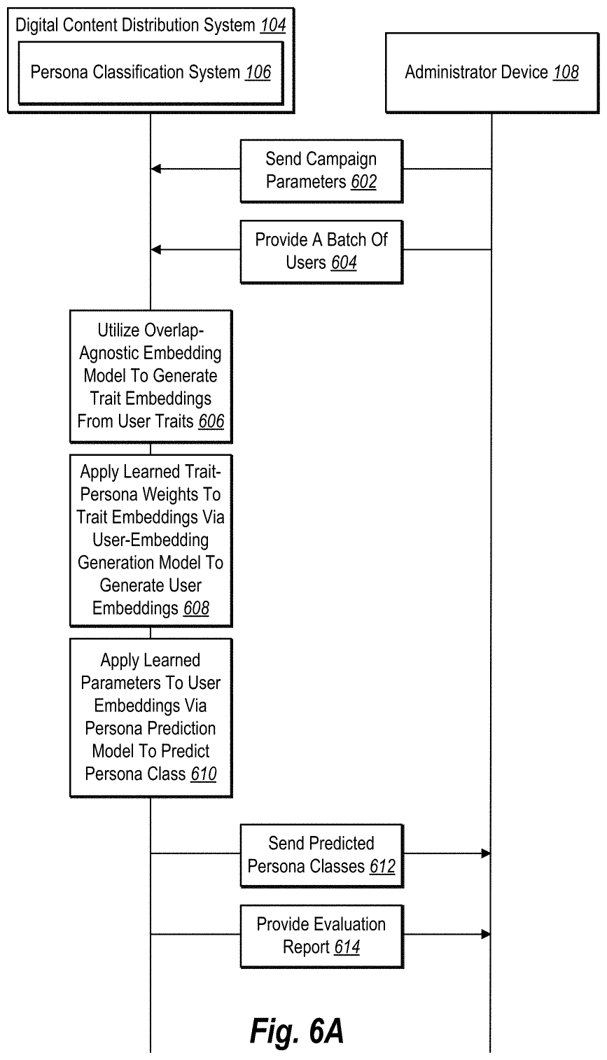

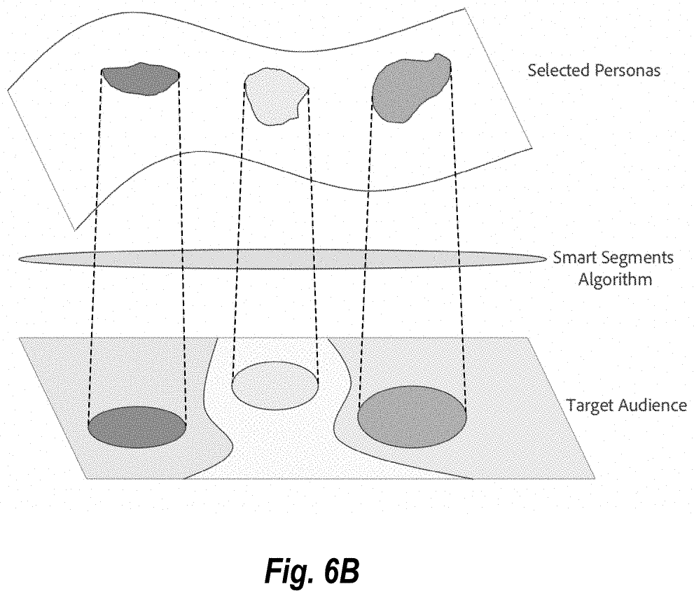

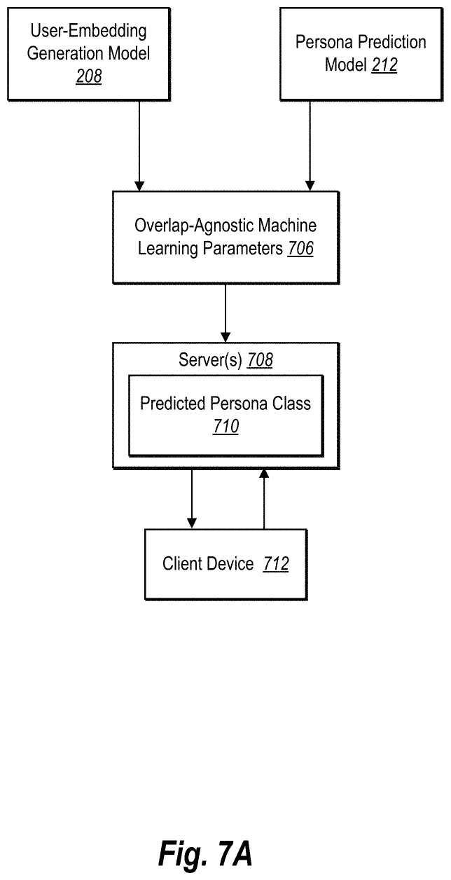

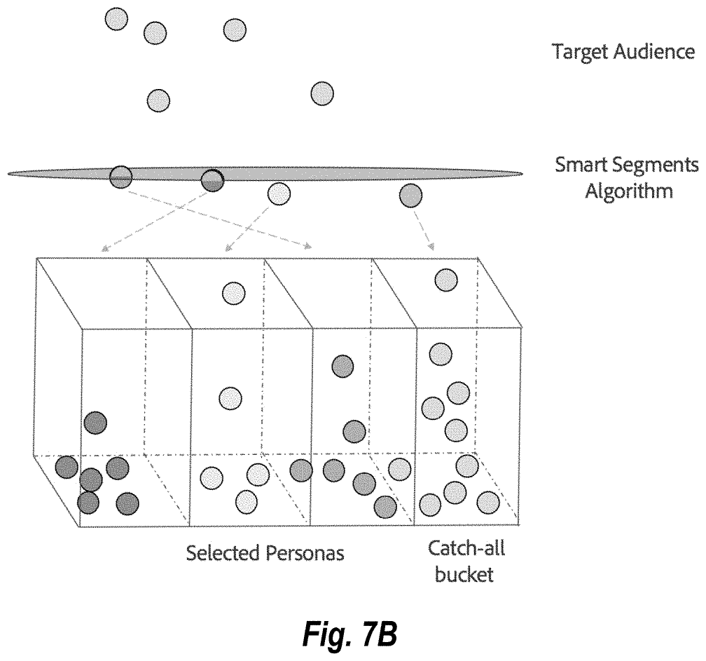

In other embodiments, the persona classification system 106 may not directly apply one or more of the overlap-agnostic embedding model 204, the user-embedding generation model 208, and the persona prediction model 212 to determine the predicted persona class 214. For example, to reduce a processing time (e.g., for real-time applications), reduce caching, and/or minimize computational resources, the persona classification system 106 may utilize learned overlap-agnostic machine learning model parameters and apply the learned overlap-agnostic machine learning model parameters to the user traits 202. In particular, the persona classification system 106 can combine overlap-agnostic machine learning model parameters to determine coefficients corresponding to individual traits and/or personas. The persona classification system 106 can then these coefficients to the user traits 202 without further determinations by the overlap-agnostic embedding model 204, the user-embedding generation model 208, and/or the persona prediction model 212. Accordingly, the process flow of FIG. 2 is merely illustrative, and alternative embodiments may omit, add to, reorder, and/or modify any aspect of the process flow of FIG. 2. Additional detail regarding real-time or offline application of the persona classification system 106 is provided below (e.g., in relation to FIGS. 6A-7B)

As described above, the persona classification system 106 can include the overlap-agnostic embedding model 204 trained to generate and/or identify trait embeddings 206. FIG. 3 illustrates a process flow 300 for training the overlap-agnostic embedding model 204 to generate trait embeddings 312 (e.g., the trait embeddings 206) in accordance with one or more embodiments of the present disclosure.

As illustrated, persona classification system 106 identifies a group of training samples, illustrated in a table 301. As shown in table 301, each training sample includes a user ID and a plurality of traits associated with the user ID (e.g. user IDs and known attributes corresponding to users/client devices that visited a website in a particular time period). Specifically, the table 301 includes a plurality of rows—where each row includes a training sample corresponding to a particular user ID—and a plurality of columns—where each column corresponds to a particular data type included in the training sample. As an illustration, the table 301 includes a first column storing the user IDs, a second column storing a gender of the corresponding user ID (i.e., the gender of the user associated with the corresponding user ID), a third column storing a client device type (e.g., laptop, personal computer, smartphone), a fourth column storing an operating system (e.g., iOS), a fifth column storing an age range, a fifth column storing a geographic location, a sixth column storing an occupation, and a seventh column storing a subscription length of the corresponding user ID (i.e., a length of time a user corresponding to the user ID has subscribed to a particular service, such as one offered by a digital content administrator associated with the administrator device 108). It should be noted that the table 301 can store a variety of traits corresponding to a target user and/or client device. In some embodiments, the table 301 stores hundreds or thousands of traits corresponding to any given target user.

In one or more embodiments, the persona classification system 106 collects and stores the training samples within the table 301 at the occurrence of particular events. For example, when an event occurs (e.g., a link is clicked), the persona classification system 106 can collect data corresponding to the event, including a user ID corresponding to the user (or device) that generated the event and the traits associated with that user ID. The persona classification system 106 can then store the user ID and corresponding traits within the table 301 as a training sample and later use the training sample to train the overlap-agnostic embedding model 204 to generate the trait embeddings 312. In some embodiments, the persona classification system 106 collects the training samples (or part of the data corresponding to a training sample) through other means, such as through direct submission of training sample data by users (e.g., via survey or creation of an online profile).

In one more embodiments, the persona classification system 106 stores training samples based on a time frame within which the training samples were collected (or the time frame within which the corresponding event occurred). For example, the persona classification system 106 can store an indication of the time frame corresponding to each training sample within the table 301. In some embodiments, the persona classification system 106 stores training samples corresponding to a first time frame within a first table and training samples corresponding to a second time frame within a second table. Thus, the persona classification system 106 can train the overlap-agnostic embedding model 204 to generate the trait embeddings 312 using training samples from a particular time frame. In some embodiments, the persona classification system 106 can combine training samples from any number of time frames and use the combination of training samples to train the overlap-agnostic embedding model 204. A time frame can be defined as a day, a week, a month, or any other suitable time frame.

As further illustrated, the persona classification system 106 can further train the overlap-agnostic embedding model 204 by applying one permutation hashing 302 to the training samples from the table 301. Specifically, the persona classification system 106 utilizes the one permutation hashing 302 to generate a plurality of sketch vectors (e.g., min-hash sketch vectors) where each sketch vector corresponds to a trait from the training samples from the table 301.

In particular, the persona classification system 106 generates trait embeddings based on a similarity between an input trait and other traits. In one or more embodiments, the persona classification system 106 generate trait embeddings that reflect the similarity. For example, the persona classification system 106 can use U to denote a population set (e.g., the set of user IDs included within the training samples used to train the overlap-agnostic embedding model 204) where U=[n] for a large integer n and U^{k} denotes the set of all k dimensional vectors (k being a positive integer) whose coordinates are in U. Given two sets A, B⊆U, where A represents the population of user IDs associated with a first trait and B represents the population of user IDs associated with a second trait, the persona classification system 106 represents the Jaccard similarity J(A, B) as follows:

$$J ( A , B ) = \frac{\vert A ⋂ B \vert}{\vert A ⋃ B \vert} \qquad ( 1 )$$

In some embodiments, because of the large quantity of data included within the training samples, the persona classification system 106 generates a sketch vector for each trait to reduce the dimensionality of the training samples while preserving their key statistics. In one or more embodiments, the persona classification system 106 generates the sketch vectors using one permutation hashing. Given a set A, the persona classification system 106 denotes the corresponding sketch vector as s(A)=(s(A)₁, . . . , s(A)ₖ). Accordingly, the persona classification system 106 can utilize the sketch vectors of A and B to obtain an unbiased estimate of the Jaccard similarity J(A, B) using equation 2 below:

$$\tilde{J} ( s ) = \frac{1}{k} {\sum }_{i ∈ [ k ]} 𝕀 ( {s ( A )}_{i} = {s ( B )}_{i} ) \qquad ( 2 )$$

In equation 2, i represents a value slot of the corresponding sketch vector and ]](⋅) represents a function that takes value 1 when the argument is true, and zero otherwise. As shown by equation 2, in one or more embodiments, the persona classification system 106 can use the sketch vectors s(A) and s(B) of sets A and B, respectively, to estimate J(A, B) by doing a pair-wise comparison of the value slots.

As further shown in FIG. 3, in one or more embodiments, the persona classification system 106 generates a plurality of densified sketch vectors 304 from the plurality of sketch vectors. In some embodiments, for example, the persona classification system 106 uses populated-value-slot-based densification to generate the densified sketch vectors 304. In particular, the persona classification system 106 generates a densified sketch vector for each sketch vector (i.e., each densified sketch vector corresponds to a trait from the training samples).

Specifically, the persona classification system 106 can improve the comparison of traits (i.e., more accurately determine the similarity between traits) by ensuring that the sketch vectors corresponding to the traits have the locality sensitive hashing (LSH) property. For example, the LSH property allows the persona classification system 106 to utilize equation 2 to accurately estimate the Jaccard similarity. In relation to sketch vector densification 304 of FIG. 3, the persona classification system 106 can define the LSH property as:

Pr(s(A)ᵢ=s(B))ᵢ=J(A,B) for i=1, . . . ,k (3)

In some embodiments, however, the sketch vectors resulting from the one permutation hashing 302 have unpopulated value slots. Accordingly, the persona classification system 106 can apply the populated-value-slot-based densification to the sketch vectors to generate densified sketch vectors 304 and maintain the LSH property. In some embodiments, the persona classification system 106 utilizes a populated-value-slot-based densification model to implement the populated-value-slot-based densification and generate densified sketch vectors 304.

As further shown in FIG. 3, in one or more embodiments, the persona classification system 106 utilizes a count sketch matrix generator (e.g., a count sketch algorithm) to generate a count sketch matrix 306 based on the plurality of densified sketch vectors generated by the sketch vector densification 304. In one or more embodiments, the persona classification system 106 configures the count sketch matrix generator so that the count sketch matrix 306 includes a pre-determined number of columns. In some embodiments, the persona classification system 106 configures the count sketch matrix generator so that the count sketch matrix 306 includes fewer columns than the number of value slots in each densified sketch vector. In other words, the count sketch matrix generator can compress the data included in the plurality of densified sketch vectors into a smaller data structure. For example, the count sketch matrix 306 includes one hundred columns, less than the one thousand value slots included in each densified sketch vector.

In one or more embodiments, each column in the count sketch matrix 306 is associated with a value. For example, each column can be associated with a value corresponding to its column index (e.g., the first column is associated with the value one, etc.). Further, each row in the count sketch matrix 306 can be associated with a particular trait.

In one or more embodiments, to generate the count sketch matrix 306, the count sketch matrix generator applies a function, such as a hash function, to a value contained within a value slot of a densified sketch vector. The results of the hash function provide a hash value within some predetermined range of values. In particular, the persona classification system 106 can configure the hash function to generate a hash value within a predetermined value range corresponding to the predetermined number of columns. The count sketch matrix generator then updates an entry of the count sketch matrix 306 for each generated value. In particular, the count sketch matrix generator identifies a location within a table that corresponds to the attribute and the value created from the hash function and then modifies that entry. In one or more embodiments, the count sketch matrix generator updates the entry by adding to the current value of the entry (e.g., +1) or subtracting from the current value of the entry (e.g., −1). The count sketch matrix generator performs this process for every value slot of every densified sketch vector to generate the count sketch matrix 306.

The count sketch matrix 306 has the property that the left singular vectors of the count sketch matrix 306 approximate the eigenvectors of a similarity matrix based on the traits from the training samples (e.g., of the table 301). As used herein, the term “similarity matrix” refers to a data structure that provides the similarity (e.g., the Jaccard similarity) between two variables. In particular, a similarity matrix based on traits has rows and columns corresponding to each trait. Accordingly, each entry has the Jaccard similarity of the trait corresponding to the row and the trait corresponding to the column.

As further illustrated in FIG. 3, in one or more embodiments, the persona classification system 106 utilizes a singular value decomposition model 308 to determine the left singular vectors of the count sketch matrix 306. The persona classification system 106 then determines the top left singular vectors 310 (i.e., the left singular vectors containing the top singular values) and uses the top left singular vectors 310 to build the left singular vector matrix. In one or more embodiments, the top left singular vectors 310 can include any number of left singular vectors.

In one or more embodiments, the persona classification system 106 builds the left singular vector matrix by stacking the top left singular vectors 310. In other words, in one or more embodiments, the persona classification system 106 utilizes the top left singular vectors 310 as the columns for the left singular vector matrix. Accordingly, each row of the left singular vector matrix provides a vector for a trait.

In one or more embodiments, the persona classification system 106 utilizes the data in each row of the left singular vector matrix as one of the trait embeddings 312 for the trait corresponding to that row. In particular, each row provides a trait embedding vector for the corresponding trait. In some embodiments, the persona classification system 106 further modifies each row to generate the trait embedding vectors. For example, in some embodiments, the persona classification system 106 can normalize the vectors provided by the left singular vector matrix to generate the trait embedding vectors. In other embodiments, the persona classification system 106 multiplies the left singular vector matrix by a diagonal matrix to generate the trait embedding vectors.

Thus, the persona classification system 106 can train the overlap-agnostic embedding model 204 to generate the trait embeddings 312. In particular, the persona classification system 106 can utilize one permutation hashing, sketch vector densification, a sketch matrix, a singular value decomposition model, and top left singular vectors to train the overlap-agnostic embedding model 204 to generate the trait embeddings 312. Indeed, in one or more embodiments, the persona classification system 106 generates trait embeddings utilizing one or more approaches described in UTILIZING ONE HASH PERMUTATION AND POPULATED-VALUE-SLOT-BASED DENSIFICATION FOR GENERATING AUDIENCE SEGMENT TRAIT RECOMMENDATIONS, U.S. patent application Ser. No. 16/367,628, filed Mar. 28, 2019, which is incorporated herein in its entirety by reference.

As described above, in addition to an overlap-agnostic embedding model 204 the persona classification system 106 can also include a user-embedding generation model 208. FIG. 4 illustrates a process flow for training the user-embedding generation model 208 to learn trait-persona weights 420 according to one or more embodiments of the present disclosure. As illustrated, the persona classification system 106 identifies a training user trait set 406 associated with a client device 404 of a training user 402.

As mentioned above, traits within the training user trait set 406 can include a variety of different features or characteristics corresponding to user and/or client device. For example, traits can indicate an operating system, browser, device type, etc. identified via an anonymous cookie. Additionally or alternatively, the traits can be known characteristics of a user (e.g., associated with a user ID). For instance, the persona classification system 106 can identify traits such as historical actions, age, or interests of a user associated with a known ID (e.g., an email address such that the traits can be recognized across different devices to which the training user is logged in). In these or other embodiments, the persona classification system 106 can identify the training user trait set 406 using training user traits as graphed, charted, mapped, etc. based on data from linked devices, known IDs, and/or other suitable sources.

In some embodiments, traits reflect frequency or timing with which other traits are expressed. For example, a baseball team's website visitor trait may correspond to the frequency of fans visiting the baseball team's website. To illustrate, the person classification system can monitor and utilize a trait that tracks if a target user has the trait of visiting a baseball team's website at least 10 times. Thus, the persona classification system 106 can utilize traits that reflect the frequency of such visits and/or the timing of such visits (e.g., a certain number of weekend visits to a website).

Of the potentially many different traits comprising the training user trait set 406, the persona classification system 106 predetermines that a persona class 410 includes at least one trait (e.g., a fan of a certain basketball team) that is part of the training user trait set 406. For example, the training user 402 may have explicitly provided input via the client device 404 in completing an online profile, survey, etc. that expressly associates the trait of a Team 1 fan with the training user 402. Accordingly, the persona class 410 is a known trait (or a plurality of known traits defining a persona class) of the training user 402.

As further shown in FIG. 4, the persona classification system 106 feeds the training user trait set 406 and the persona class 410 to the overlap-agnostic embedding model 204. Based on the training of the overlap-agnostic embedding model 204 as described above in conjunction with FIG. 3, the overlap-agnostic embedding model 204 can identify training user trait embeddings 414 and a persona embedding 416. For example, in some embodiments, the overlap-agnostic embedding model 204 generates a database of traits and corresponding trait embeddings. The persona classification system 106 can access the database and identify trait embeddings corresponding to the training user trait set. The persona classification system 106 can also identify persona embeddings 416 (e.g., by identifying one or more trait embeddings from the database for traits defining the persona class).

In turn, the persona classification system 106 feeds the training user trait embeddings 414 and the persona embedding 416 to the user-embedding generation model 208 to learn the trait-persona weights 420. In general, the trait-persona weights 420 are learned values that map one or more trait embeddings corresponding to a user to a persona embedding corresponding to the user such that each of the trait-persona weights 420 respectively maps at least one of the training user trait embeddings 414 relative to the persona embedding 416. In more detail, the trait-persona weights 420 can, in combination with each other, minimize a Euclidean distance in vector space between the persona embedding 416 and the training user trait embeddings 414 (individually and/or as a whole).

In these or other embodiments, the Euclidean distance in vector space between persona embedding 416 and the training user trait embeddings 414 reflects a degree of similarity. For example, a farther Euclidean distance separating a training user trait embedding 414 and the persona embedding 416 can be indicative of less relative similarity, while a shorter Euclidean distance separating a training user trait embedding 414 and the persona embedding 416 can be indicative of more relative similarity. Accordingly, training user trait embeddings 414 having more relative similarity to the persona embedding 416 may correspond to larger trait-persona weights 420, while training user trait embeddings 414 having less relative similarity to the persona embedding 416 may correspond to smaller trait-persona weights 420. However, given the interconnectedness of the training user trait embeddings 414 to each other, the user-embedding generation model 208 in some embodiments determines the optimal trait-persona weights 420 such that the training user trait embeddings 414 as a whole are as close as possible to the persona embedding 416 in vector space.

To learn the trait-persona weights 420, the user-embedding generation model 208 uses one or more mathematical algorithms or models (e.g., a neural network or other machine learning model) based on inputs that include the training user trait embeddings 414 and the persona embedding 416. In one or more embodiments, the user-embedding generation model 208 includes a linear regression model as one example model for determining the trait-persona weights 420.

To illustrate, the user-embedding generation model 208 can combine (e.g., average or concatenate) trait embeddings corresponding to a user to generate a baseline user embedding. The user-embedding generation model 208 can then compare the baseline user embedding with a known persona class (e.g., a known trait) to learn trait-persona weights. Applying these trait persona-weights generates a weighted user embedding corresponding to the user (that more accurately aligns the user embeddings to known persona classes corresponding to training users in vector space).

For example, let A be the user-trait matrix, i.e.,

A(i,j)=1/0

Depending on if user i has trait j: Suppose vⱼ is the vector corresponding to the trait j, then the baseline for user embedding is:

$${u}_{i} = {\sum }_{j} {A}_{ij} {v}_{j} / \sqrt{\vert {T}_{j} \vert} ,$$

where |Tⱼ| is the number of users with trait j.

For trait-focused optimization, the following can apply. If the user-embedding generation model 208 is provided a particular trait j₀ (i.e., a trait for a known persona class of the user), then the user-embedding generation model 208 can learn a weighted embedding for users,

$${\tilde{u}}_{i} = {\sum }_{j \neq {j}_{0}} {A}_{ij} {w}_{j} {v}_{j} , \\ and$$

$$\begin{matrix}min \\ w\end{matrix} {\sum }_{i} {( {\tilde{u}}_{i}^{T} {v}_{{j}_{0}} - {A}_{{ij}_{0}} )}^{2}$$

A regularized version of the above can be represented as:

$$\frac{{1}^{min}}{{2}_{w}} {\sum }_{i} {( {\tilde{u}}_{i}^{T} {v}_{{j}_{0}} - {A}_{{ij}_{0}} )}^{2} + \frac{λ}{2} {‖ w ‖}^{2}$$

The gradient g=(g₁, . . . , gₙ) is given by:

$${g}_{j} = \{ \begin{matrix}{\sum }_{i} ( {\tilde{u}}_{i}^{T} {v}_{{j}_{0}} - {A}_{{ij}_{0}} ) {A}_{ij} {v}_{j}^{T} {v}_{{j}_{0}} + λ {w}_{j} & if j \neq {j}_{0} \\ λ {w}_{j} & if j = {j}_{0}\end{matrix}$$

Note that Σᵢ means the summation is over the users. When the user-embedding generation model 208 performs SGD, the user-embedding generation model 208 can sample the users and hence this summation need not appear. Further, the user-embedding generation model 208 can also start with:

$${w}_{j} = \frac{1}{\sqrt{\vert {T}_{j} \vert}}$$

Additionally or alternatively, the user-embedding generation model 208 can use an l₁ regularization.

Further, under trait-focused optimization, the following may apply in a closed form solution approach (e.g., including a linear regression approach). Expanding ũᵢ from the foregoing, the above objective can be expressed as:

$$\frac{1}{2} {\sum }_{i} {( {\sum }_{j \neq {j}_{0}} {w}_{j} {A}_{ij} {v}_{j}^{T} {v}_{{j}_{0}} - {A}_{{ij}_{0}} )}^{2}$$

This is equivalent to:

$$f ( w ) = {min}_{w} \frac{1}{2} {‖ {\tilde{A}}_{{\hat{j}}_{0}} w - {y}_{{j}_{0}} ‖}^{2} + \frac{λ}{2} {‖ w ‖}^{2}$$

Here, yⱼ_{₀} is the vector of labels corresponding to trait j₀, and Ã_{ĵ}_{₀} is a matrix whose dimension is #users by #traits and whose entries are given by:

Ã_{ĵ}_{₀}(i,j)=vⱼ^{T}vⱼ_{₀}

if user i has trait j and zero otherwise. Also, the user-embedding generation model 208 can zero out the j₀^{th} column, i.e.,

Ã_{ĵ}_{₀}(i,j₀)=0 for all i

In this manner, the user-embedding generation model 208 can ensure the j₀^{th} trait is not included. Therefore, the gradient with respect to w is given by:

∇_{w}f(w)=Ã_{ĵ}_{₀}^{T}(Ã_{ĵ}_{₀}w−yⱼ_{₀})+λw

Equating this to zero at the optimum, the user-embedding generation model 208 can determine that:

$$0 = {\tilde{A}}_{{\hat{j}}_{0}}^{T} ( {\tilde{A}}_{{\hat{j}}_{0}} w - {y}_{{j}_{0}} ) + λ w = > ( {\tilde{A}}_{{\hat{j}}_{0}}^{T} {\tilde{A}}_{{\hat{j}}_{0}} + λ I ) w = {\tilde{A}}_{{\hat{j}}_{0}}^{T} {y}_{{j}_{0}} = > w = {( {\tilde{A}}_{{\hat{j}}_{0}}^{T} {\tilde{A}}_{{\hat{j}}_{0}} + λ I )}^{- 1} {\tilde{A}}_{{\hat{j}}_{0}}^{T} {y}_{{j}_{0}}$$

In the case of multiple traits j₀, . . . , jₖ as a baseline, the user-embedding generation model 208 can sum up the cost functions from the foregoing sections for each:

$$f ( w ) = {min}_{w} \frac{1}{2} {\sum }_{l = 0}^{k} {‖ {\tilde{A}}_{l} w - {y}_{{j}_{l}} ‖}^{2} + \frac{λ}{2} {‖ w ‖}^{2}$$

Here, yⱼ_{ₗ} is the vector of labels corresponding to trait jₗ and Ãₗ is a matrix whose dimension is #users by #traits and whose entries are given by:

Ãₗ(i,j)=vⱼ^{T}vⱼ_{ₗ}.

if user i has trait j and zero otherwise. Also, the user-embedding generation model 208 can zero out all of the j₀, . . . , jₖ′^{th} columns, i.e., if j∈{j₁, . . . , jₖ}

Ã_{ĵ}(i,j)=o for all i

Like before, the user-embedding generation model 208 can compute the derivative as:

$${∇}_{w} f ( w ) = {\sum }_{l} {\tilde{A}}_{l}^{T} ( {\tilde{A}}_{l} w - {y}_{{j}_{0}} ) + λ w$$

Equating this to zero (at the optimum), the user-embedding generation model 208 determines:

$$0 = {\sum }_{l} {\tilde{A}}_{l}^{T} ( {\tilde{A}}_{l} w - {y}_{{j}_{l}} ) + λ w = > ( {\sum }_{l} {\tilde{A}}_{l}^{T} {\tilde{A}}_{l} + λ I ) w = {\sum }_{l} {\tilde{A}}_{l}^{T} {y}_{{j}_{l}} = > w = {( {\sum }_{l} {\tilde{A}}_{l}^{T} {\tilde{A}}_{l} + λ I )}^{- 1} {\sum }_{l} {\tilde{A}}_{l}^{T} {y}_{{j}_{l}}$$

Variations to the above acts and algorithms are herein contemplated. For example, the user-embedding generation model 208 can employ the following acts and algorithms to learn the trait-persona weights 420. As before, if the user-embedding generation model 208 is provided a particular trait j₀, then the user-embedding generation model 208 can learn a weighted embedding for users

$${\tilde{u}}_{i} = {\sum }_{j \neq {j}_{0}} {A}_{ij} {w}_{j} {v}_{j}$$

The weights (i.e., the trait-persona weights 420) are learned as follows. For each trait j, the user-embedding generation model 208 determines wⱼ by minimizing:

$$\frac{1}{2} {min}_{{w}_{j}} {\sum }_{i} {( {A}_{ij} {w}_{j} \cdot {v}_{j}^{T} {v}_{{j}_{0}} - {A}_{{ij}_{0}} )}^{2}$$

Let N₁ be the number of users who have both traits j and j₀, and N₂ be the number of users who have trait j but not j₀. Then, the immediately preceding minimization is equivalent to:

$$\frac{1}{2} {min}_{{w}_{j}} {{N}_{1} ( {w}_{j} \cdot {v}_{j}^{T} {v}_{{j}_{0}} - 1 )}^{2} + \frac{1}{2} {{N}_{2} ( {w}_{j} \cdot {v}_{j}^{T} {v}_{{j}_{0}} - 0 )}^{2}$$

This has a closed form solution given by:

$${w}_{j} = \frac{{N}_{1}}{( {N}_{1} + {N}_{2} ) \cdot {v}_{j}^{T} {v}_{{j}_{0}}}$$

Then, the above minimization is equivalent to:

$${min}_{{w}_{j}} ( \frac{1}{2} {{N}_{1} ( {w}_{j} \cdot {v}_{j}^{T} {v}_{{j}_{0}} - 1 )}^{2} + \frac{1}{2} {{N}_{2} ( {w}_{j} \cdot {v}_{j}^{T} {v}_{{j}_{0}} - 0 )}^{2} )$$

The L2 regularized version of the above is:

$${min}_{{w}_{j}} \frac{1}{2} {\sum }_{i} {( {A}_{ij} {w}_{j} \cdot {v}_{j}^{T} {v}_{{j}_{0}} - {A}_{{ij}_{0}} )}^{2} + \frac{λ}{2} {w}_{j}^{2}$$

Let N be the total number of users. Then, using the notation as above, the user-embedding generation model 208 can determine:

$${min}_{{w}_{j}} ( \frac{1}{2} {{N}_{1} ( {w}_{j} \cdot {v}_{j}^{T} {v}_{{j}_{0}} - 1 )}^{2} + \frac{1}{2} {{N}_{2} ( {w}_{j} \cdot {v}_{j}^{T} {v}_{{j}_{0}} - 0 )}^{2} + \frac{1}{2} N λ {w}_{j}^{2} )$$

This has a closed form solution given by:

$${w}_{j} = \frac{{N}_{1} \cdot {v}_{j}^{T} {v}_{{j}_{0}}}{( {N}_{1} + {N}_{2} ) \cdot {( {v}_{j}^{T} {v}_{{j}_{0}} )}^{2} + N λ}$$

The mixed L1-L2 regularized version of the above is:

$${min}_{{w}_{j}} \frac{1}{2} {\sum }_{i} {( {A}_{ij} {w}_{j} \cdot {v}_{j}^{T} {v}_{{j}_{0}} - {A}_{{ij}_{0}} )}^{2} + \frac{λ}{2} {w}_{j}^{2} + μ \vert {w}_{j} \vert$$

Let N be the total number of users. Then, using the notation as above, the user-embedding generation model 208 can further determine:

$${min}_{{w}_{j}} ( \frac{1}{2} {{N}_{1} ( {w}_{j} \cdot {v}_{j}^{T} {v}_{{j}_{0}} - 1 )}^{2} + \frac{1 \vert}{2} {{N}_{2} ( {w}_{j} \cdot {v}_{j}^{T} {v}_{{j}_{0}} - 0 )}^{2} + \frac{1}{2} N λ {w}_{j}^{2} + N μ \vert {w}_{j} \vert$$

This has a closed form solution given by:

$${w}_{j} = \{ \begin{matrix}\frac{{N}_{1} \cdot {v}_{j}^{T} {v}_{{j}_{0}} - N μ}{( {N}_{1} + {N}_{2} ) \cdot {( {v}_{j}^{T} {v}_{{j}_{0}} )}^{2} + N λ} & if {N}_{1} \cdot {v}_{j}^{T} {v}_{{j}_{0}} - N μ \geq 0 \\ \frac{{N}_{1} \cdot {v}_{j}^{T} {v}_{{j}_{0}} + N μ}{( {N}_{1} + {N}_{2} ) \cdot {( {v}_{j}^{T} {v}_{{j}_{0}} )}^{2} + N λ} & if {N}_{1} \cdot {v}_{j}^{T} {v}_{{j}_{0}} + N μ \leq 0 \\ 0 & otherwise\end{matrix}$$

This can be expressed slightly more compactly as:

$${w}_{j} = sgn ( {N}_{1} \cdot {v}_{j}^{T} {v}_{{j}_{0}} - N μ ) \frac{( \vert {N}_{1} \cdot {v}_{j}^{T} . {v}_{{j}_{0}} \vert - N μ ) +}{( {N}_{1} + {N}_{2} ) \cdot {( {v}_{j}^{T} {v}_{{j}_{0}} )}^{2} + N λ}$$

In the above, sgn(⋅) is the sign function, i.e., sgn(5)=1 and sgn(−3)=−1. Also, the user-embedding generation model 208 uses (x)₊=max {x, 0}. In words, wⱼ is set to zero if N₁. vⱼ^{T}vⱼ_{₀}<Nμ, and otherwise set to:

$$sgn ( {N}_{1} \cdot {v}_{j}^{T} {v}_{{j}_{0}} - N μ ) \cdot \frac{( \vert {N}_{1} \cdot {v}_{j}^{T} . {v}_{{j}_{0}} \vert - N μ ) +}{( {N}_{1} + {N}_{2} ) \cdot {( {v}_{j}^{T} {v}_{{j}_{0}} )}^{2} + N λ}$$

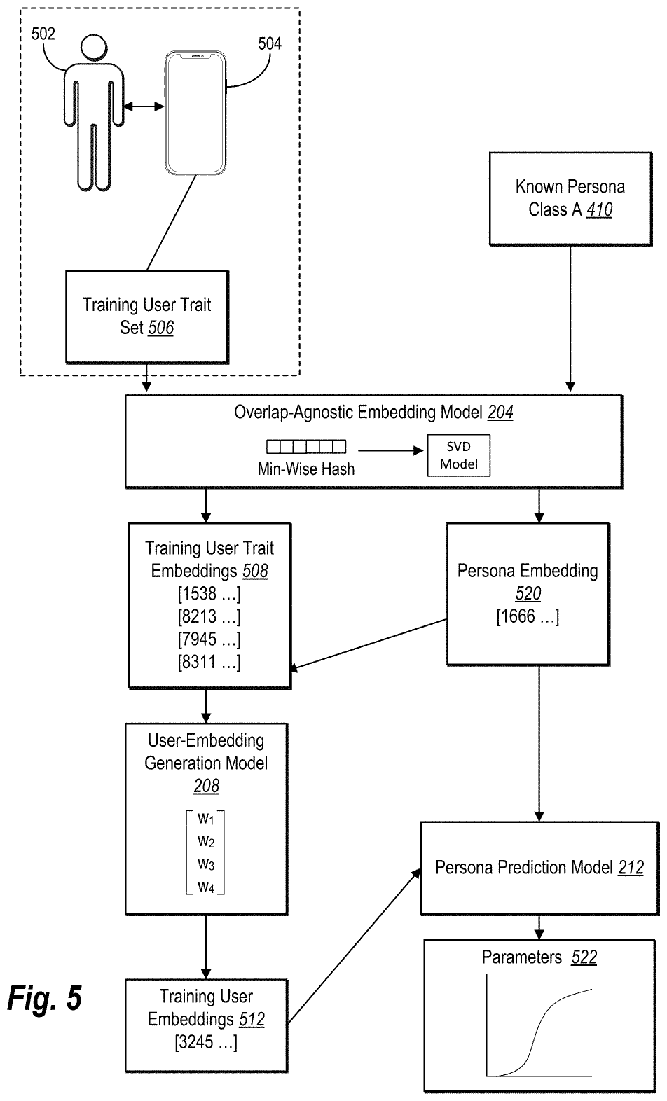

As described above, in addition to a user embedding-generation model, the persona classification system 106 can also include a persona prediction model 212. FIG. 5 illustrates a process flow for training the persona prediction model 212 to learn parameters 522 according to one or more embodiments of the present disclosure. As illustrated, the persona classification system 106 identifies a training user trait set 506 associated with a client device 504 of a training user 502 (e.g., the training user trait set 406, the client device 404, and/or the training user 402 of FIG. 4). Additionally or alternatively, the training user trait set 406 can be associated with one or more traits associated with a user identified by a known ID (e.g., an email address such that the traits can be recognized across different devices to which the training user is logged in). The persona classification system 106 feeds the training user trait set 506 and the persona class 410 to the overlap-agnostic embedding model 204. Based on the training of the overlap-agnostic embedding model 204 as described above in conjunction with FIG. 3, the overlap-agnostic embedding model 204 can identify training user trait embeddings 508 and a persona embedding 520 (e.g., the training user trait embeddings 414 and/or the persona embedding 416 of FIG. 4).

As further illustrated, the persona classification system 106 can feed the training user trait embeddings 508 and the persona embedding 520 to the user-embedding generation model 208. In turn, based on the training of the user-embedding generation model 208 as described above in conjunction with FIG. 4, the user-embedding generation model 208 can identify training user embeddings 512 based on inputs that include the training user trait embeddings 508 and the persona embedding 520. In particular, the persona classification system 106 can use the learned trait-persona weights 420 to generate the training user embeddings 512 at the user-embedding generation model 208, for example, by applying the learned trait-persona weights 420 to the training user trait embeddings 508, the persona embedding 520, or a combination of the training user trait embeddings 508 and the persona embedding 520.

In addition, as shown in FIG. 5, the persona classification system 106 feeds the training user embeddings 512 and the persona embedding 520 to the persona prediction model 212 for learning the parameters 522. In general, the parameters 522 are learned values that map a user embedding to a persona embedding. In more detail, for example, the parameters 522 can, in combination with each other, minimize a Euclidean distance in vector space between the persona embedding 520 and the training user embeddings 512 (individually and/or as a whole).

To learn the parameters 522, the persona prediction model 212 uses one or more mathematical algorithms or models (e.g., a neural network or other machine learning model) based on inputs that include the training user embeddings 512 and the persona embedding 520. In one or more embodiments, the persona prediction model 212 includes a logistic regression model as one example model for determining the parameters 522.

Based on the learned parameters 522, the persona classification system 106 can predict a persona class of a target user. In particular, by training the persona prediction model 212 in relation to the training user trait set 506 known to include the persona class 410, the persona prediction model 212 can learn how to map traits of a target user against the persona class 410. In more detail, by learning how to map the training user embeddings 512 to the persona embedding 520, the persona prediction model 212 can then map user embeddings of a target user to a persona embedding (e.g., such that the persona classification system 106 can determine whether a target user is also likely a fan of a certain basketball team when such information about the target user is unknown, including cases where the available information of the target user doesn't overlap with known fans of the certain basketball team).

As discussed above, as the persona classification system 106 and/or other components of the environment 100 can predict a persona class for a target user by utilizing overlap-agnostic machine learning model parameters that include the trait-persona weights 420 and the parameters 522. FIG. 6A illustrates an example sequence diagram illustrating acts and/or algorithms to accomplish these tasks in accordance with one or more embodiments of the present disclosure. While FIG. 6A illustrates acts according to one or more embodiments, alternative embodiments may omit, add to, reorder, and/or modify any of the acts shown in FIG. 6A. For example, the persona classification system 106 can implement one or more of the acts of FIG. 6A in parallel with or in series to real-time applications for predicting a persona class of a target user. In an example scenario, the persona classification system 106 can efficiently predict a persona class of a target user in real-time notwithstanding incomplete information about a device associated with the target user. Then, after utilizing an example batch approach outlined in the acts of FIG. 6A, the persona classification system 106 can update/further specify the prediction of the persona class for the target user.

As shown, FIG. 6A illustrates a sequence diagram with acts by which the persona classification system 106 determines predicted persona classes in an “offline” mode (i.e., not in real-time) for a batch of target users. As illustrated in FIG. 6A, the persona classification system 106 performs an act 602 of receiving campaign parameters from the administrator device 108. The campaign parameters can include a variety of data regarding a marketing campaign. In particular, the campaign parameters can include a target audience (e.g., all users who joined a fantasy basketball league at via a website in the last thirty days), selected personas (e.g., a fan of Team 1, a fan of Team 2, or a fan of Team 3, etc.), target user data (e.g., name, birth month/day/year, gender identity, country, phone number, email address, zip code, etc.), cookies, and any other suitable data.

At an act 604, the persona classification system 106 receives a batch of users (e.g., some or all of the fantasy league participants who joined in the last thirty days) from the administrator device 108. Although illustrated in FIG. 6A as the batch of users being sent from the administrator device 108, in other embodiments, the persona classification system 106 may receive the batch of users from another remote server (e.g., the DSP server 118, a third-party server, etc.).

At an act 606, the persona classification system 106 analyzes the user traits of each target user in the target audience via the overlap-agnostic embedding model 204 to generate trait embeddings. In these or other embodiments, applying user traits at the act 606 may include the persona classification system 106 identifying trait embedding values already included (e.g., learned) in the overlap-agnostic embedding model 204. Additionally or alternatively, applying user traits at the act 606 may include the persona classification system 106 modifying trait embedding values previously learned at the overlap-agnostic embedding model 204 and/or learning entirely new trait embedding values at the overlap-agnostic embedding model 204.

At an act 608, the persona classification system 106 applies learned trait-persona weights to the trait embeddings from the act 606 at the user-embedding generation model 208 to generate user embeddings. For example, the user-embedding generation model 208 may combine the trait-persona weights with the trait embeddings from the act 606 in a variety of different ways. In these or other embodiments, applying learned trait-persona weights to trait embeddings at the act 608 may include the persona classification system 106 identifying trait-persona weights already included (e.g., learned) in the user-embedding generation model 208 that correspond to the trait embeddings from the act 606. For example, the user-embedding generation model 208 may identify previously learned trait-persona weights as corresponding to the trait embeddings from the act 606 of the new fantasy league members to generate the user embeddings. Additionally or alternatively, applying learned trait-persona weights to trait embeddings may include the persona classification system 106 modifying one or more trait-persona weights previously learned at the user-embedding generation model 208 and/or learning entirely new trait-persona weights at the user-embedding generation model 208 for generating the user embeddings.

At the act 610, the persona classification system 106 applies learned parameters to the user embeddings from the act 608 at the persona prediction model 212 to predict the persona classes for the batch of target users. For example, the persona prediction model 212 may combine the learned parameters with the user embeddings from the act 608 in a variety of different ways for predicting the persona classes. In these or other embodiments, applying learned parameters to user embeddings at the act 610 may include the persona classification system 106 identifying parameters already included (e.g., learned) in the persona prediction model 212 that correspond to the user embeddings from the act 608. For example, the persona prediction model 212 may apply previously learned parameters to the user embeddings from the act 608 of the new fantasy league members to predict what team fans they are. Additionally or alternatively, applying learned parameters to user embeddings at the act 610 may include the persona classification system 106 modifying one or more parameters previously learned at the persona prediction model 212 and/or learning entirely new parameters at the persona prediction model 212 for predicting the persona classes of the batch of target users.

At an act 612, the persona classification system 106 sends the predicted persona classes of the batch of target users to the administrator device 108. The persona classification system 106 may do so in a variety of ways. For example, the persona classification system 106 may send the predicted personas to the administrator device 108 in one or more batches (e.g., at intervals or at approximately the same time). Alternatively, the persona classification system 106 may send the predicted personas to the administrator device 108 on a rolling basis as the predicted persona class for a given target user is completed. Additionally or alternatively, in some embodiments, the persona classification system 106 can send the predicted persona classes of the batch of target users to the DSP server 118.

At an act 614, the persona classification system 106 provides an evaluation report to the administrator device 108. In some embodiments, the evaluation report includes an indication of each target user and their respective propensity values for including or belonging to one or more persona classes (e.g., 90% likelihood of belonging to a first persona, 85% likelihood of belonging to second persona class, etc.). Additionally or alternatively, the evaluation report can include target audience statistics (e.g., audience size, proportions of target users to persona classes, similar/unique traits associated with each persona class, main traits for each persona class, persona class reach, users who have multiple potential persona classes, etc.), persona class prediction accuracy (e.g., persona class tolerances), constraints, conditions, and/or any other suitable data.

In these or other embodiments, the evaluation report at the act 614 can include an indication of an overall model accuracy (e.g., of the overlap-agnostic machine learning model). For example, prior to or part of the act 614, the persona classification system 106 can obtain an overall model accuracy by performing accuracy tests using one or more test batches of data associated with known outcomes or other truth data. Accordingly, the persona classification system 106 can indicate in the evaluation report one or more aspects of the overall model accuracy.

Although FIG. 6A illustrates a particular set of acts, the persona classification system 106 can perform different acts or acts in different orders. For example, in some embodiments, the persona classification system 106 determines persona classifications by comparing user embeddings with persona class embeddings. For instance, the persona classification system 106 can generate a user embedding by aggregating trait embeddings corresponding to traits of a target user (e.g., utilizing the user-embedding generation model). The persona classification system 106 can directly compare the user embedding to a persona class embedding (e.g., an embedding of one or more traits defining a persona class). For instance, the persona classification system 106 can determine the Euclidian distance between the user embedding and the persona class embedding in vector space and select the persona class based on the distance (e.g., select the persona class with the smallest Euclidian distance from the user embedding).

FIG. 6B illustrates a diagram indicating the persona classification system 106 mapping, in an offline mode, some example selected personas to a target audience of a batch of target users, in accordance with one or more embodiments of the present disclosure. In particular, FIG. 6B illustrates how the persona classification system 106 maps the selected personas (e.g., Team 1 fans, Team 2 fans, and Team 3 fans) against an entire user base of the target audience (e.g., all of the new fantasy league participants who joined in the last thirty days).

As discussed above, the persona classification system 106 and/or other components of the environment 100 can predict a persona class for a target user by utilizing overlap-agnostic machine learning model parameters that include the trait-persona weights 420 and the parameters 522. FIGS. 7A-7B, for example, illustrate diagrams depicting an “online” scenario in which the persona classification system 106 and/or other components of the environment 100 can predict a persona class in real-time while the target user accesses a digital asset, in accordance with one or more embodiments of the present disclosure. In particular, FIG. 7A illustrates an example embodiment in which the persona classification system 106 does not directly employ one or more of the overlap-agnostic embedding model 204, the user-embedding generation model 208, and the persona prediction model 212 to determine the predicted persona class 710. For example, to reduce a processing time (e.g., for real-time applications), reduce caching, and/or minimize computational resources, the persona classification system 106 may apply learned overlap-agnostic machine learning model parameters 706 to target user traits without further determinations by the overlap-agnostic embedding model 204, the user-embedding generation model 208, and/or the persona prediction model 212.

As shown in FIG. 7A, the diagram includes the user-embedding generation model 208, the persona prediction model 212, overlap-agnostic machine learning model parameters 706, server(s) 708, a predicted persona class 710, and a client device 712. In these or other embodiments, the server(s) 708 can include one or more of the server(s) 102, the administrator device 108, the DSP server 118, and/or another remote server as described above in conjunction with FIG. 1. Accordingly, the server(s) 708 can include a single server, multiple servers performing in tandem on the same or similar acts and algorithms, or multiple servers performing at separate times and/or on separate acts and algorithms.

As illustrated in FIG. 7A, the persona classification system 106 identifies the user-embedding generation model 208 and the persona prediction model 212. Specifically, the persona classification system 106 identifies trait-persona weights from the user-embedding generation model 208 and persona prediction model parameters (e.g., parameters of a logistic regression model). The persona classification system 106 combines the user-embedding generation model 208 and the persona prediction model 212 to generate the overlap-agnostic machine learning model parameters 706. In particular, the persona classification system 106 aggregates the learned trait-persona weights and the learned parameters to form one or more coefficients as the overlap-agnostic machine learning model parameters 706. For example, the persona classification system 106 can determine coefficients particular to specific traits and/or personas (e.g., trait and persona coefficients). The persona classification system 106 can apply these coefficients directly (in real-time) to predict persona classes for target users/client devices.

Indeed, as shown in FIG. 7A, the one or more server(s) 708 determines a predicted persona class 710 based on the overlap-agnostic machine learning model parameters 706. Specifically, as illustrated in FIG. 7A, a target user accesses (via the client device 712) a digital asset provided by server(s) 708. For example, the target user accesses a website hosted by the one or more server(s) 708. As mentioned above, the server(s) 708 can identify one or more traits corresponding to the target user. The server(s) 708 can identify coefficients (e.g., trait and persona coefficients) corresponding to the one or more traits and utilize the coefficients to predict a persona class. For example, the server(s) 708 can sum coefficients for the one or more traits (corresponding to specific to persona classes) and select the persona class with the largest resulting value. Based on the predicted persona class 710, one or more of the server(s) 708 can send persona-based digital content to the client device 712 in real-time while accessing the digital asset.

In this manner, the persona classification system 106 can identify persona classes corresponding to target users in real-time (and without requiring overlap between traits). Indeed, the persona classification system 106 can apply coefficients corresponding traits/personas in very little time and with very little processing power (e.g., within milliseconds). Accordingly, the persona classification system 106 can identify persona classes near-instantaneously, while a client device accesses a website (e.g., while a client device loads a website). The persona classification system 106 can thus identify persona classes and distribute digital content as part of real-time bidding environments (e.g., where multiple entities bid on impression opportunities to provide to the client device as they access digital assets) or other real-time digital content distribution applications.

As briefly mentioned above, FIG. 7B illustrates diagrams depicting an “online” scenario in which the persona classification system 106 and/or other components of the environment 100 can predict a persona class in real-time while the target user accesses a digital asset, in accordance with one or more embodiments of the present disclosure. In particular, FIG. 7B illustrates the server(s) 708 predicting a persona class for each individual user in a target audience in response to the user accessing a digital asset offered by the server(s) 708. For example, as illustrated in FIG. 7B, the server(s) 708 may determine the target users in the target audience correspond to a first persona class, a second persona class, a third persona class, and a “catch-all” persona class for the target users that do not sufficiently fit (e.g., within a threshold fit) the first three persona classes. For instance, the server(s) 708 may determine that target users having a sum of the coefficients (described above) that fails to satisfy a threshold sum for any given persona class may belong to the catch-all persona class. Additionally or alternatively, the server(s) 708 may determine that target users having a highest sum of coefficients exceeding a threshold sum for a first persona class belongs to or includes the first persona class. Similarly, the server(s) 708 may determine that target users having a highest sum of coefficients exceeding a threshold sum for a second persona class belongs to or includes the second persona class, and so forth.

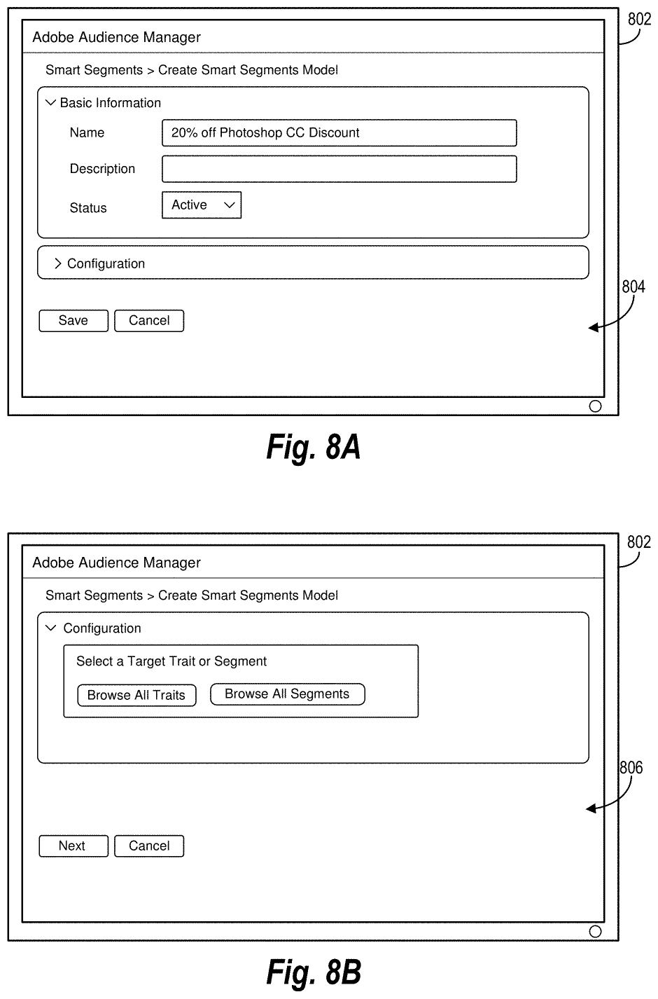

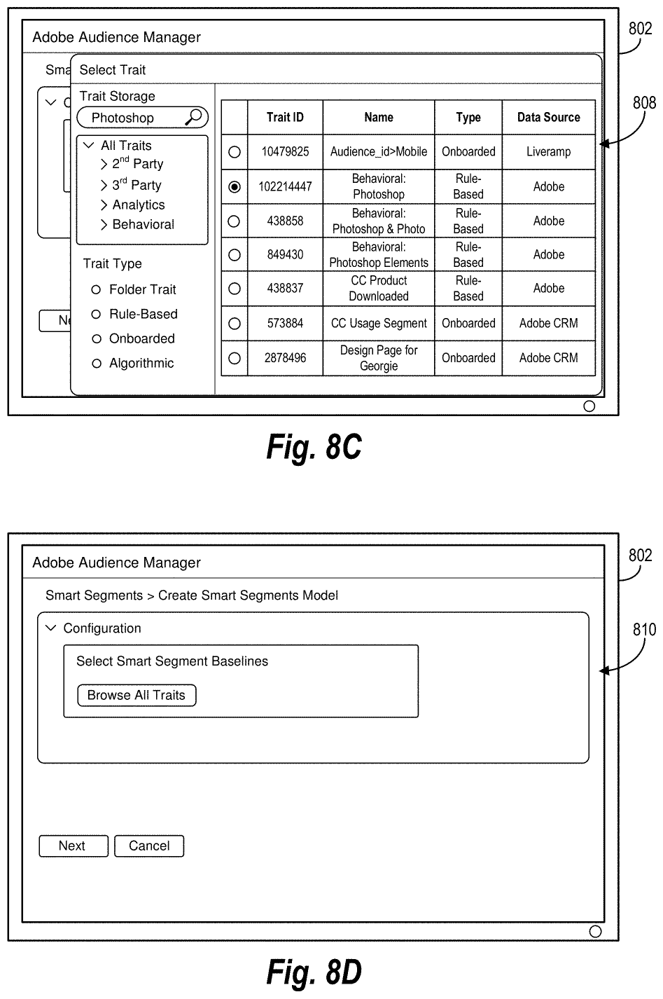

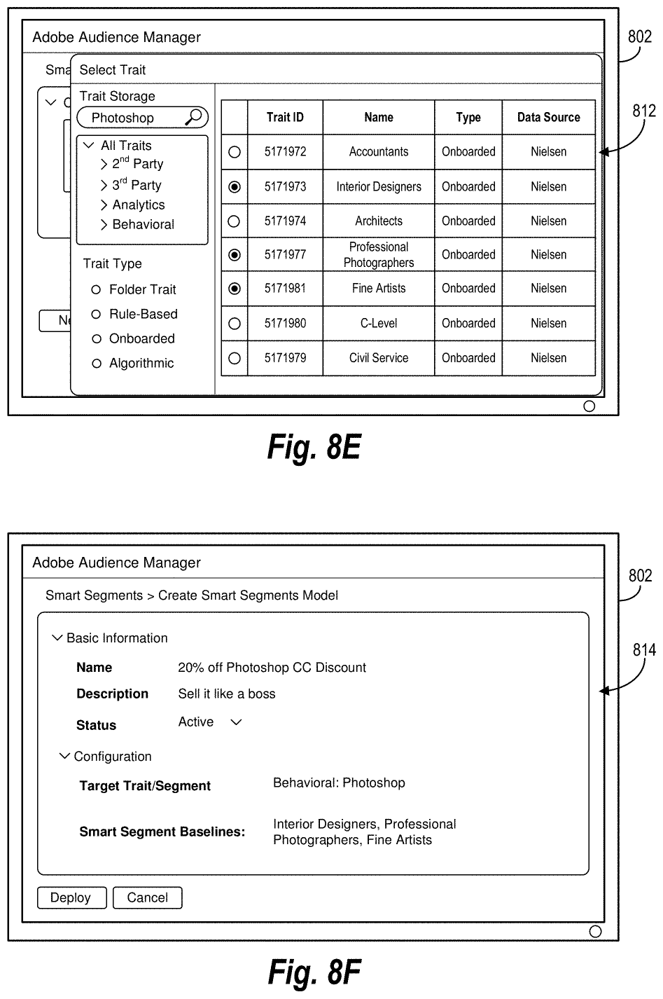

As mentioned above, an administrator device 108 can communicate with the digital content distribution system 104, for example, to send campaign parameters, provide a batch of target users, apply one or more overlap-agnostic machine learning model parameters to target user traits, etc. FIGS. 8A-8D illustrate an example computing device 802 displaying example user interfaces 804-814 for communicating with the digital content distribution system 104, in accordance with at least one embodiment of the present disclosure. In these or other embodiments, the computing device 802 may be the same as or similar to the administrator device 108, the client devices 112a-112n, and/or the DSP server 118 described above in conjunction with FIG. 1 and other figures.

For example, FIG. 8A illustrates the digital content distribution system 104 and/or the persona classification system 106 providing the user interface 804 for creating a smart segments model. In particular, the user interface 804 can receive one or more user inputs (e.g., from an administrator) to provide a name, description, status, configuration, etc. that identifies or otherwise defines aspects of a smart segments model for one or more particular digital content campaigns. For example, the name of the smart segments model can reflect digital content (e.g., a “20% off Photoshop CC Discount”) that the digital content distribution system 104 sends to client devices when classified as belonging to a given persona class as part of a particular digital content campaign.

FIG. 8B illustrates the digital content distribution system 104 and/or the persona classification system 106 providing the user interface 806 for selecting one or more aspects of a configuration of the overlap-agnostic machine learning model in the persona classification system 106. In particular, the user interface 806 can receive one or more user inputs (e.g., from an administrator) to select a target trait or segment. For example, the user interface 806 can receive a user input to browse, upload, or create a new target trait or segment.

FIG. 8C illustrates the digital content distribution system 104 and/or the persona classification system 106 providing the user interface 808 for selecting a target trait associated with a set of target users or a target audience. In particular, the user interface 808 can receive one or more user inputs (e.g., from an administrator) to select a target trait associated with target trait identifiers such as a trait ID, name, type, data source, etc. For example, the user interface 808 can receive user inputs to filter, sort, search, and compare target traits among other suitable functions.

Additionally or alternatively, the user interface 808 can receive user inputs to exclude a trait or set of traits (e.g., by folder or origin) such that the excluded trait or set of traits are not included or utilized in the overlap-agnostic machine learning model. For instance, upon identifying a trait to exclude, the persona classification system 106 can implement processes to omit the trait from a variety of acts discussed above. For example, the persona classification system 106 can exclude a selected trait from training an overlap-agnostic embedding model. Similarly, the persona classification system 106 can exclude traits in generating trait embeddings, generating user embeddings, identifying a target audience, generating model parameters, or generating coefficients.

FIG. 8D illustrates the digital content distribution system 104 and/or the persona classification system 106 providing the user interface 810 for selecting one or more aspects of a configuration of the overlap-agnostic machine learning model in the persona classification system 106. In particular, the user interface 810 can receive one or more user inputs (e.g., from an administrator) to select a baseline trait or a persona class. For example, the user interface 810 can receive a user input to browse, upload, or create a new persona class for assessment in the overlap-agnostic machine learning model (e.g., classifying target users as corresponding to the persona class).

FIG. 8E illustrates the digital content distribution system 104 and/or the persona classification system 106 providing the user interface 812 for selecting a baseline trait (e.g., persona class). In particular, the user interface 812 can receive one or more user inputs (e.g., from an administrator) to select a persona class associated with trait identifiers such as a trait ID, name, type, data source, etc. For example, the user interface 812 can receive user inputs to filter, sort, search, and compare persona classes among other suitable functions.

FIG. 8F illustrates the digital content distribution system 104 and/or the persona classification system 106 providing the user interface 814 for confirming one or more aspects of the overlap-agnostic machine learning model (e.g., as provided in the foregoing user interfaces 804-812). In particular, the user interface 814 can receive one or more user inputs (e.g., from an administrator) to edit, preview, cancel, deploy, beta test, or perform some other suitable action relating to the overlap-agnostic machine learning model. Additionally or alternatively, the user interface 814 can be a summary page saved for later, printed, shared, etc.

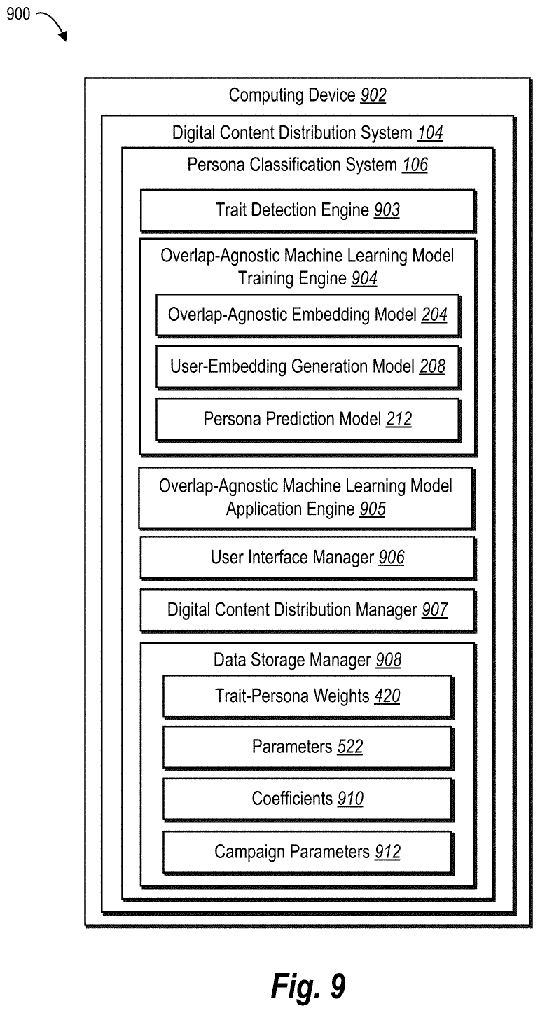

Turning now to FIG. 9, additional detail is provided regarding a computing system 900, including components and capabilities of the persona classification system 106 in accordance with one or more embodiments. As shown, the persona classification system 106 is implemented by a computing device 902, including the digital content distribution system 104 of the computing device 902. In some embodiments, the components of the persona classification system 106 can be implemented by a single device (e.g., the server(s) 102, the administrator device 108, the DSP server 118, and/or the client devices 112a-112n of FIG. 1) or multiple devices. As shown, the persona classification system 106 includes a trait detection engine 903, an overlap-agnostic machine learning model training engine 904, an overlap-agnostic machine learning model application engine 905, a user interface manager 906, a digital content distribution manager 907, and a data storage manager 908. Each is discussed in turn below.

As just mentioned, the persona classification system 106 can include the trait detection engine 903. For instance, the trait detection engine 903 can identify, receive, detect, and/or determine traits corresponding to a target user (e.g., a client device corresponding to a target user or a known ID of a target user such as email address such that the traits can be recognized across different devices to which the target user is logged in). For example, as discussed above, the trait detection engine 903 can identify traits from a database corresponding to a target user or from tracking cookies. Additionally or alternatively, the trait detection engine 903 can identify traits as graphed, charted, mapped, etc. based on data from linked devices, known IDs, and/or other suitable sources.

As shown in FIG. 9, the persona classification system 106 also includes the overlap-agnostic machine learning model training engine 904 (which trains the overlap-agnostic embedding model 204, the user-embedding generation model 208, and the persona prediction model 212). Although FIG. 9 illustrates the overlap-agnostic embedding model 204, the user-embedding generation model 208, and the persona prediction model 212 as part of the overlap-agnostic machine learning model training engine 904, the persona classification system 106 can store these trained models as part of the data storage manager 908 (as discussed below). The overlap-agnostic machine learning model training engine 904 trains, learns, teaches, and/or generates each of the overlap-agnostic embedding model 204, the user-embedding generation model 208, and/or the persona prediction model 212. For example, the overlap-agnostic machine learning model training engine 904 can identify, determine, receive, request, and/or learn user traits for training the overlap-agnostic embedding model 204 how to determine trait embeddings that correspond to the user traits. Additionally, the overlap-agnostic machine learning model training engine 904 can identify, determine, send, receive, generate, and/or learn the trait-persona weights 420 for training the user-embedding generation model 208 how to map trait embeddings to a persona embedding. Further, the overlap-agnostic machine learning model training engine 904 can identify, determine, send, receive, generate, and/or learn the parameters 522 for training the persona prediction model 212 how to map user embeddings to a persona embedding for predicting a persona class.

As shown in FIG. 9, the persona classification system 106 also includes the overlap-agnostic machine learning model application engine 905. The overlap-agnostic machine learning model application engine 905 can identify, determine, apply, and/or transmit one or more learned outputs from the overlap-agnostic embedding model 204, the user-embedding generation model 208, and/or the persona prediction model 212. As discussed above the overlap-agnostic machine learning model application engine 905 can apply models offline or online (e.g., in real-time as client devices access digital assets).

As shown in FIG. 9, the persona classification system 106 can also include the user interface manager 906. The user interface manager 906 can provide, manage, and/or control a graphical user interface (or simply “user interface”). In particular, the user interface manager 906 may generate and display a user interface by way of a display screen composed of a plurality of graphical components, objects, and/or elements that allow a user to perform a function. For example, the user interface manager 906 can receive user inputs from a user, such as a click/tap to view a digital asset like a product webpage. Additionally, the user interface manager 906 can present a variety of types of information, including text, digital media items, persona-based digital content, or other information.

The data storage manager 908 maintains data for the persona classification system 106. The data storage manager 908 can maintain data of any type, size, or kind, as necessary to perform the functions of the persona classification system 106, including the trait-persona weights 420, the parameters 522, and the coefficients 910 described above (in addition to other data, such as models, digital content for distribution to client devices, trait embeddings, user embeddings, and/or persona classes).

Each of the components of the computing device 902 can include software, hardware, or both. For example, the components of the computing device 902 can include one or more instructions stored on a computer-readable storage medium and executable by processors of one or more computing devices, such as a client device or server device. When executed by the one or more processors, the computer-executable instructions of the persona classification system 106 can cause the computing device(s) (e.g., the computing device 902) to perform the methods described herein. Alternatively, the components of the computing device 902 can include hardware, such as a special-purpose processing device to perform a certain function or group of functions. Alternatively, the components of the computing device 902 can include a combination of computer-executable instructions and hardware.

Furthermore, the components of the computing device 902 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the computing device 902 may be implemented as a stand-alone application, such as a desktop or mobile application. Furthermore, the components of the computing device 902 may be implemented as one or more web-based applications hosted on a remote server.

The components of the computing device 902 may also be implemented in a suite of mobile device applications or “apps.” To illustrate, the components of the computing device 902 may be implemented in an application, including but not limited to ADOBE® ANALYTICS, ADOBE® AUDIENCE MANAGER, ADOBE® EXPERIENCE MANAGER, ADOBE® CAMPAIGN, ADOBE® ADVERTISING, ADOBE® TARGET, or ADOBE® COMMERCE CLOUD. Product names, including “ADOBE” and any other portion of one or more of the foregoing product names, may include registered trademarks or trademarks of Adobe Systems Incorporated in the United States and/or other countries.

FIGS. 1-9, the corresponding text, and the examples provide several different systems, methods, techniques, components, and/or devices of the persona classification system 106 in accordance with one or more embodiments. In addition to the above description, one or more embodiments can also be described in terms of flowcharts including acts for accomplishing a particular result. For example, FIG. 10 illustrates a flowchart of a series of acts 1000 for predicting a persona class of a target user in accordance with one or more embodiments. The persona classification system 106 may perform one or more acts of the series of acts 1000 in addition to or alternatively to one or more acts described in conjunction with other figures, such as FIG. 6A. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown, the series of acts 1000 includes an act 1002 of identifying a target user of a client device and user traits corresponding to the target user. For example, the act 1002 can include identifying the target user of the client device and the user traits in response to the client device accessing a digital asset via a remote server. Additionally or alternatively, the act 1002 can include identifying a batch of a plurality of target users, the plurality of target users comprising the target user.

The series of acts 1000 further includes an act 1004 of identifying an overlap-agnostic machine learning model parameter corresponding to the user traits of the target user and a persona class. For example, the act 1004 can include identifying the overlap-agnostic machine learning model parameter learned by an overlap-agnostic machine learning model based on comparing an embedding of the persona class and embeddings of a plurality of traits of a plurality of training users in a vector space.

The series of acts 1000 further includes an act 1006 of applying the overlap-agnostic machine learning model parameters to the user traits of the target user to determine the persona class. For example, the act 1006 can include: performing the applying while a client device accesses a digital asset via a remote server. Alternatively, the act 1006 can include applying the one or more overlap-agnostic machine learning model parameters to the user traits of the target user offline by: identifying a batch of a plurality of target users, the plurality of target users comprising the target user; and providing a plurality of persona classes corresponding to the batch of the plurality of target users to a remote server, the plurality of personas comprising the persona class corresponding to the target user.

Providing more focus on determining the persona class, the overlap-agnostic machine learning model can further include a persona prediction model, and applying the one or more overlap-agnostic machine learning model parameters can include utilizing the persona prediction model to determine the persona class based on the embedding of the target user generated utilizing the user-embedding generation model.

It is understood that the outlined acts in the series of acts 1000 are only provided as examples, and some of the acts may be optional, combined into fewer acts, or expanded into additional acts without detracting from the essence of the disclosed embodiments. As an example of an additional or alternative act not shown in FIG. 10, an act in the series of acts 1000 may include providing digital content to the client device of the target user while the client device accesses the digital asset. As another example additional or alternative act, an act in the series of acts 1000 may include: generating embeddings of the user traits utilizing the overlap-agnostic embedding model, wherein distances between the embeddings of the user traits in the vector space reflect similarities between the corresponding user traits; and generating an embedding of the target user utilizing the user-embedding generation model based on the trait embeddings of the user traits.

In another example of additional or alternative acts, one or more acts in the series of acts 1000 can include causing a computer system to train the user-embedding generation model by: identifying a set of training traits for a training user of the plurality of training users, wherein the training user belongs to the persona class; utilizing the overlap-agnostic embedding model to generate a set of embeddings for the plurality of training traits of the training user and the embedding of the persona class; and learning trait-persona weights for the set of training traits relative to the persona class based on the embeddings for the plurality of training traits and the embedding of the persona class.

In another example of additional or alternative acts, one or more acts in the series of acts 1000 can include identifying an additional set of training traits for an additional training user of the plurality of training users, wherein the additional training user belongs to the persona class; utilizing the user-embedding generation model to generate an embedding for the additional training user based on one or more of the trait-persona weights; and learning parameters of the persona prediction model based on the embedding for the additional training user and the embedding of the persona class. In these or other embodiments of the foregoing acts, the user-embedding generation model can comprise a linear regression model, the persona prediction model can comprise a logistic regression model, and the overlap-agnostic machine learning model parameters reflect one or more of the trait-persona weights of the linear regression model and one or more of the parameters of logistic regression model.

In addition (or in the alternative) to the acts described above, in some embodiments, the series of acts 1000 include performing a step for determining a persona class for a target user utilizing overlap-agnostic machine learning model parameters. For instance, the algorithms and acts described in relation to FIG. 2, FIG. 6A (e.g., the acts 606-610), and FIG. 7A can comprise the corresponding acts for a step for determining a persona class for a target user utilizing overlap-agnostic machine learning model parameters.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

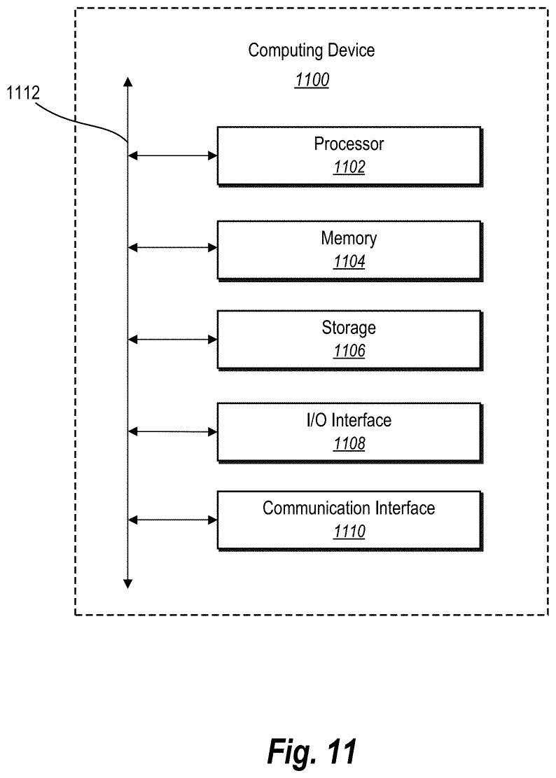

FIG. 11 illustrates a block diagram of an example computing device 1100 that may be configured to perform one or more of the processes described above. One will appreciate that one or more computing devices, such as the computing device 1100 may represent the computing devices described above (e.g., the computing device 1102, the server(s) 102, the administrator device 108, the DSP server 118, and the client devices 112a-112n). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of the computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. In a digital medium environment for distributing targeted digital content to client devices across computer networks, a computer-implemented method for implementing overlap agnostic machine learning models to determine persona classes for target users comprising:
identifying a target user of a client device and user traits corresponding to the target user;
a step for determining a persona class for the target user utilizing parameters of an overlap-agnostic machine learning model; and
providing digital content to the target user based on the persona class.

2. The computer-implemented method of claim 1, wherein the overlap-agnostic machine learning model comprises an overlap-agnostic embedding model, a user-embedding generation model, and persona prediction model.

3. The computer-implemented method of claim 2, wherein:
the user-embedding generation model comprises a linear regression model; and
the persona prediction model comprises a logistic regression model.

4. The computer-implemented method of claim 1, wherein providing the digital content to the target user comprises providing the digital content in real-time by:
identifying the target user of the client device and the user traits in response to the client device accessing a digital asset via a remote server; and
while the client device accesses the digital asset via the remote server:
performing the step for determining the persona class for the target user utilizing parameters of the overlap-agnostic machine learning model; and
providing digital content to the target user based on the persona class.

5. A non-transitory computer-readable medium storing instructions that, when executed by at least one processor, cause a computer system to:
identify a target user of a client device and user traits corresponding to the target user; and
determine a persona class corresponding to the target user of the client device from a plurality of persona classes, by:
identifying one or more overlap-agnostic machine learning model parameters corresponding to the user traits of the target user and the persona class,
wherein the one or more overlap-agnostic machine learning model parameters are learned by an overlap-agnostic machine learning model based on comparing an embedding of the persona class and embeddings of a plurality of traits of a plurality of training users in a vector space; and
applying the one or more overlap-agnostic machine learning model parameters to the user traits of the target user to determine the persona class.

6. The non-transitory computer-readable medium of claim 5, further comprising instructions that, when executed by the at least one processor, cause the computer system to provide digital content to the client device of the target user in real-time based on the persona class by:
identifying the target user of the client device and the user traits in response to the client device accessing a digital asset via a remote server; and
while the client device accesses the digital asset via the remote server:
applying the one or more overlap-agnostic machine learning model parameters to the user traits of the target user to determine the persona class; and
providing the digital content to the client device of the target user.

7. The non-transitory computer-readable medium of claim 5, further comprising instructions that, when executed by the at least one processor, cause the computer system to apply the one or more overlap-agnostic machine learning model parameters to the user traits of the target user offline by:
identifying a batch of a plurality of target users, the plurality of target users comprising the target user; and
providing a plurality of persona classes corresponding to the batch of the plurality of target users to a remote server, the plurality of personas comprising the persona class corresponding to the target user.

8. The non-transitory computer-readable medium of claim 5, wherein the overlap-agnostic machine learning model comprises an overlap-agnostic embedding model and a user-embedding generation model, and further comprising instructions that, when executed by the at least one processor, cause the system to:
generate embeddings of the user traits utilizing the overlap-agnostic embedding model, wherein distances between the embeddings of the user traits in the vector space reflect similarities between the corresponding user traits; and
generate an embedding of the target user utilizing the user-embedding generation model based on the trait embeddings of the user traits.

9. The non-transitory computer-readable medium of claim 8, wherein the overlap-agnostic machine learning model further comprises a persona prediction model, and applying the one or more overlap-agnostic machine learning model parameters comprises utilizing the persona prediction model to determine the persona class based on the embedding of the target user generated utilizing the user-embedding generation model.

10. The non-transitory computer-readable medium of claim 9, further comprising instructions that, when executed by the at least one processor, cause the computer system to train the user-embedding generation model by:
identifying a set of training traits for a training user of the plurality of training users, wherein the training user belongs to the persona class;
utilizing the overlap-agnostic embedding model to generate a set of embeddings for the plurality of training traits of the training user and the embedding of the persona class; and
learning trait-persona weights for the set of training traits relative to the persona class based on the embeddings for the plurality of training traits and the embedding of the persona class.

11. The non-transitory computer-readable medium of claim 10, further comprising training the persona prediction model by:
identifying an additional set of training traits for an additional training user of the plurality of training users, wherein the additional training user belongs to the persona class;
utilizing the user-embedding generation model to generate an embedding for the additional training user based on one or more of the trait-persona weights; and
learning parameters of the persona prediction model based on the embedding for the additional training user and the embedding of the persona class.

12. The non-transitory computer-readable medium of claim 11, wherein the user-embedding generation model comprises a linear regression model, the persona prediction model comprises a logistic regression model, and the overlap-agnostic machine learning model parameters reflect one or more of the trait-persona weights of the linear regression model and one or more of the parameters of the logistic regression model.

13. A system comprising:
at least one processor; and
at least one non-transitory computer-readable storage medium storing instructions that, when executed by the at least one processor, cause the system to:
generate, utilizing an overlap-agnostic embedding model, a plurality of trait embeddings for a plurality of traits;
generate, utilizing the overlap-agnostic embedding model, a plurality of persona embeddings for a plurality of persona classes;
train, based on the plurality of trait embeddings and the plurality of persona embeddings, an overlap-agnostic machine learning model; and
in response to identifying a target user of a client device having a set of traits, utilize the overlap-agnostic machine learning model to identify a persona class for the target user based on the set of traits.

14. The system of claim 13, further comprising instructions that, when executed by the at least one processor, cause the system to generate the plurality of trait embeddings utilizing the overlap-agnostic embedding model by:
generating a plurality of min-hash sketch vectors corresponding to the plurality of traits; and
utilizing a singular value decomposition model to generate the plurality of trait embeddings based on the plurality of min-hash sketch vectors, wherein distances between the plurality of trait embeddings in vector space reflects similarities between the plurality of trait embeddings.

15. The system of claim 13, wherein the overlap-agnostic machine learning model comprises a user-embedding generation model and a persona prediction model.

16. The system of claim 15, further comprising instructions that, when executed by the at least one processor, cause the system to train the overlap-agnostic machine learning model by:
identifying traits for a training user, wherein the training user belongs to a persona class of the plurality of persona classes;
determine trait embeddings corresponding to the traits for the training user from the plurality of trait embeddings and a persona embedding corresponding to the persona class from the plurality of persona embeddings; and
train the user-embedding generation model by learning trait-persona weights for the traits of the training user relative to the persona class based on the trait embeddings and the persona embedding.

17. The system of claim 16, further comprising instructions that, when executed by the at least one processor, cause the system to train the overlap-agnostic machine learning model by:
identifying additional traits for an additional training user, wherein the additional training user belongs to the persona class;
utilizing the user-embedding generation model to generate a user embedding for the additional training user; and
learning parameters of the persona prediction model based on the user embedding for the additional training user and the persona class.

18. The system of claim 15, further comprising instructions that, when executed by the at least one processor, cause the system to utilize the overlap-agnostic machine learning model to identify a persona class based on the set of traits by:
generating a user embedding of the target user utilizing the user-embedding generation model; and
determining the persona class utilizing the persona prediction model based on the user embedding of the target user.

19. The system of claim 15, further comprising instructions that, when executed by the at least one processor, cause the system to utilize the overlap-agnostic machine learning model to identify a persona class based on the set of traits by:
generate a user embedding of the target user utilizing the user-embedding generation model; and
comparing the user embedding of the target user with a persona embedding of the persona class.

20. The system of claim 15, further comprising instructions that, when executed by the at least one processor, cause the system to utilize the overlap-agnostic machine learning model to identify a persona class based on the set of traits by:
generating coefficients based on trait-persona weights of the user-embedding generation model and parameters of the persona prediction model; and
apply a set of coefficients corresponding to the set of traits from the coefficients to determine the persona class.
